(19) United States
(12) Patent Application Publication
(10) Pub. No.: US 2025/0292149 A1
(43) Pub. Date: Sep. 18, 2025

(54) Data Center Monitoring And Management Operation Including An Asset Utilization Forecast Operation Including a Feature Clustering Operation

(71) Applicant: Dell Products L.P., Round Rock, TX (US)

(72) Inventors: Ramakanth Kanagovi, Hyderabad (IN); Guhesh Swaminathan, Chennai (IN); Rajan Kumar, Nawada (IN)

(21) Appl. No.: 18/604,891

(22) Filed: Mar. 14, 2024

(51) Int. Cl. G06N 20/00

(52) U.S. Cl. CPC G06N 20/00

(57) ABSTRACT

A system, method, and computer-readable medium for performing a data center monitoring and management operation. The data center monitoring and management operation includes: monitoring a workload executing on a data center asset; analyzing utilization of the data center asset when the data center asset executes the workload; training a machine learning model using the utilization of the data center asset when executing the workload, the training the machine learning model including performing a feature clustering operation using the utilization of the data center asset to provide separate groups of machine learning features; and, generating a data center asset utilization forecast using the machine learning model.

### BACKGROUND OF THE INVENTION

### Field of the Invention

The present invention relates to information handling systems. More specifically, embodiments of the invention relate to performing a data center monitoring and management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a method for performing a data center monitoring and management operation, comprising: monitoring a workload executing on a data center asset; analyzing utilization of the data center asset when the data center asset executes the workload; training a machine learning model using the utilization of the data center asset when executing the workload, the training the machine learning model including performing a feature clustering operation using the utilization of the data center asset to provide separate groups of machine learning features; and, generating a data center asset utilization forecast using the machine learning model.

In another embodiment the invention relates to a system comprising: a processor; a data bus coupled to the processor; and, a non-transitory, computer-readable storage medium embodying computer program code, the non-transitory, computer-readable storage medium being coupled to the data bus, the computer program code interacting with a plurality of computer operations and comprising instructions executable by the processor and configured for: monitoring a workload executing on a data center asset; analyzing utilization of the data center asset when the data center asset executes the workload; training a machine learning model using the utilization of the data center asset when executing the workload, the training the machine learning model including performing a feature clustering operation using the utilization of the data center asset to provide separate groups of machine learning features; and, generating a data center asset utilization forecast using the machine learning model.

In another embodiment the invention relates to a computer-readable storage medium embodying computer program code, the computer program code comprising computer executable instructions configured for: monitoring a workload executing on a data center asset; analyzing utilization of the data center asset when the data center asset executes the workload; training a machine learning model using the utilization of the data center asset when executing the workload; and, generating a data center asset utilization forecast using the machine learning model.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a block diagram of a data center monitoring and management environment;

FIG. 3 shows a functional block diagram of the performance of certain data center monitoring and management operations;

FIG. 4 shows a block diagram of a data center monitoring and management console;

FIG. 5 is a simplified block diagram showing the performance of certain utilization management operations;

FIG. 6 is a table showing example utilization analytics used in the performance of a utilization forecast operation to forecast the utilization of certain data center assets used to service a particular workload;

FIG. 7 is a table showing example machine learning features used in the performance of a utilization forecast operation to forecast the utilization of certain data center assets used to service a particular workload;

FIG. 8 shows utilization intervals, and associated interval segments, used in the performance of a utilization forecast operation to forecast the utilization of certain data center assets used to service a particular workload;

FIG. 9 shows example utilization intervals, and associated interval segments, used to forecast the utilization of certain data center assets used to service a particular workload;

FIGS. 10a through 10c are a flowchart showing the performance of certain utilization management operations;

FIG. 11 shows example utilization intervals, and associated interval segments, used in the performance of feature clustering and machine learning (ML) regression analysis operations; and

FIGS. 12a through 12c are a flowchart showing the performance of certain feature clustering and ML regression analysis operations.

### DETAILED DESCRIPTION

A system, method, and computer-readable medium are disclosed for performing a data center monitoring and management operation, described in greater detail herein. Various aspects of the invention reflect an appreciation that it is common for a typical data center to monitor and manage tens, if not hundreds, of thousands of different assets, such as certain computing and networking devices, as described in greater detail herein. Certain aspects of the invention likewise reflect an appreciation that such data center assets, which may be distributed, are typically implemented to work in combination with one another for a particular purpose. Likewise, various aspects of the invention reflect an appreciation that such purposes generally involve the performance of a wide variety of tasks, operations, and processes to service certain workloads.

Various aspects of the invention likewise reflect an appreciation that such tasks, operations, and processes may include allocating the utilization of one or more data center assets, or one or more components thereof, to service a particular workload during a particular time interval, or a segment thereof. Certain aspects of the invention likewise reflect an appreciation that it may be beneficial to revise such allocation on a periodic basis. As an example, a workload's utilization of the data center assets it was originally allocated may increase over time, and as a result, throughput or response times may be adversely affected. Conversely, the same workload's utilization of the data center assets it was originally allocated may decrease over time, and as a result, the previously allocated data center assets may be underutilized. Likewise, the workload's utilization of the data center assets it was originally allocated may be cyclical in nature, increasing during certain intervals of time and decreasing during others. Consequently, various aspects of the invention reflect an appreciation that the ability to forecast a workload's utilization of one or more data center assets, or one or more components thereof, during a particular time interval, or a segment thereof, and revise such allocations accordingly would be advantageous.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

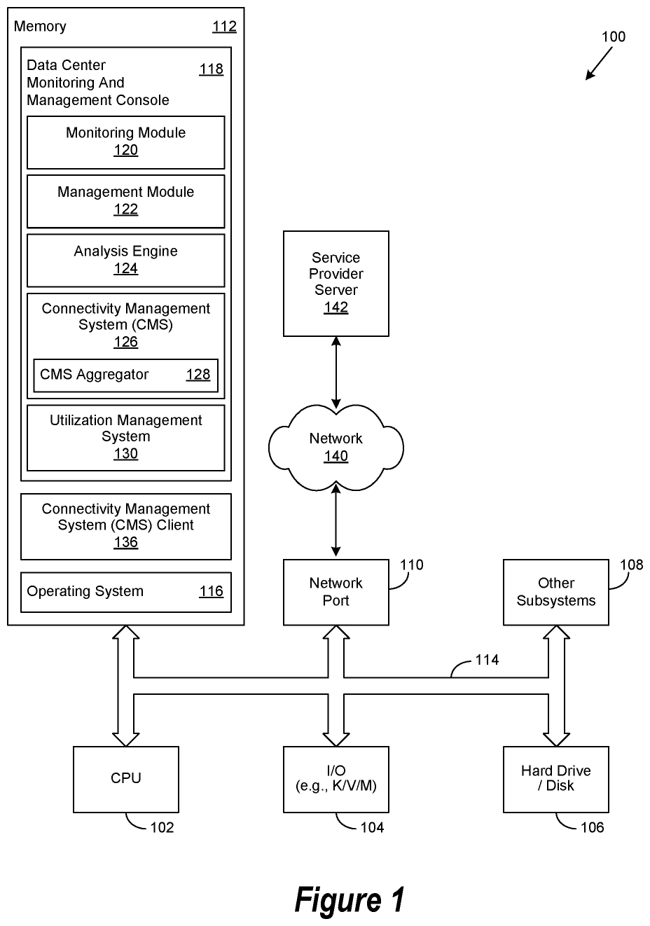

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a data center monitoring and management console 118, or a connectivity management system (CMS) client 136. In one embodiment, the information handling system 100 is able to download the data center monitoring and management console 118, or the CMS client 136, or both, from the service provider server 142. In another embodiment, the functionality respectively provided by the data center monitoring and management console 118, or the CMS client 136, or both, may be provided as a service from the service provider server 142.

In certain embodiments, the data center monitoring and management console 118 may include a monitoring module 120, a management module 122, an analysis engine 124, a connectivity management system (CMS) 126, and a utilization management system 130, or a combination thereof. In certain embodiments, the CMS 126 may be implemented to include a CMS aggregator 128. In certain embodiments, the data center monitoring and management console 118 may be implemented to perform a data center monitoring and management operation. In certain embodiments, the information handling system 100 may be implemented to include either a CMS 126, or a CMS client 136, or both.

In certain embodiments, the data center monitoring and management operation may be performed during operation of an information handling system 100. In various embodiments, performance of the data center monitoring and management operation may result in the realization of improved monitoring and management of certain data center assets, as described in greater detail herein. In certain embodiments, the CMS 126 may be implemented in combination with the CMS client 136 to perform a connectivity management operation, described in greater detail herein. As an example, the CMS 126 may be implemented on one information handling system 100, while the CMS client 136 may be implemented on another, as likewise described in greater detail herein.

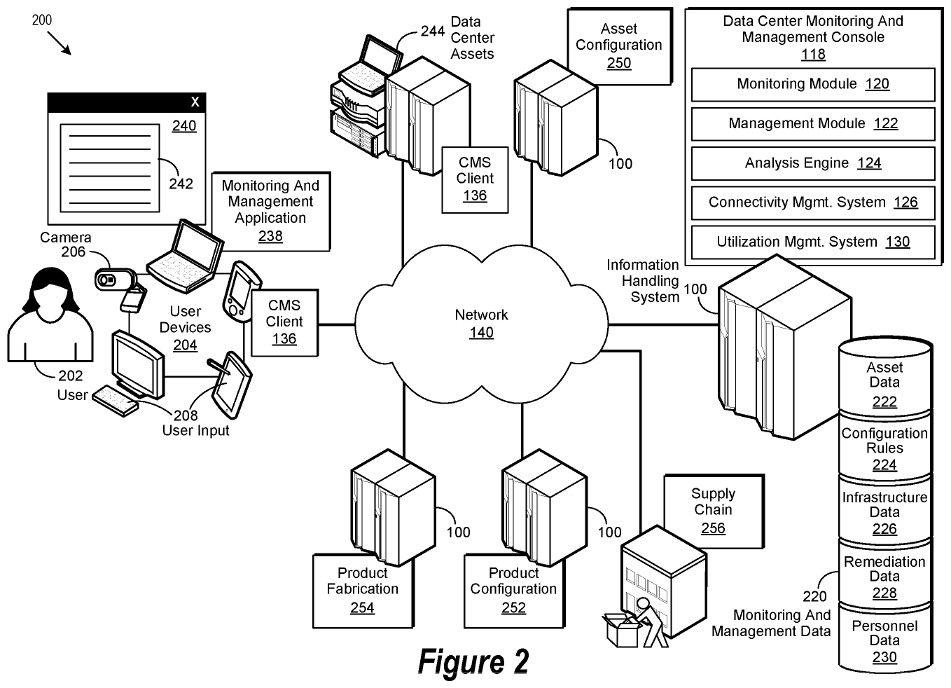

FIG. 2 is a simplified block diagram of a data center monitoring and management environment implemented in accordance with an embodiment of the invention. As used herein, a data center broadly refers to a building, a dedicated space within a building, or a group of buildings, used to house a collection of interrelated data center assets 244 implemented to work in combination with one another for a particular purpose. As likewise used herein, a data center asset 244 broadly refers to anything, tangible or intangible, that can be owned, controlled, or enabled to produce value as a result of its use within a data center. In certain embodiments, a data center asset 244 may include a product, or a service, or a combination of the two.

As used herein, a tangible data center asset 244 broadly refers to a data center asset 244 having a physical substance, such as a computing or network device. Examples of computing devices may include personal computers (PCs), laptop PCs, tablet computers, servers, mainframe computers, Redundant Arrays of Independent Disks (RAID) storage units, their associated internal and external components, and so forth. Likewise, examples of network devices may include routers, switches, hubs, repeaters, bridges, gateways, and so forth. Other examples of a tangible data center asset 244 may include certain data center personnel, such as a data center system administrator, operator, or technician, and so forth. Other examples of a tangible data center asset 244 may include certain maintenance, repair, and operations (MRO) items, such as replacement and upgrade parts for a particular data center asset 244. In certain embodiments, such MRO items may be in the form of consumables, such as air filters, fuses, fasteners, and so forth.

As likewise used herein, an intangible data center asset 244 broadly refers to a data center asset 244 that lacks physical substance. Examples of intangible data center assets 244 may include software applications, software services, firmware code, and other non-physical, computer-based assets. Other examples of intangible data center assets 244 may include digital assets, such as structured and unstructured data of all kinds, still images, video images, audio recordings of speech and other sounds, and so forth. Further examples of intangible data center assets 244 may include intellectual property, such as patents, trademarks, copyrights, trade names, franchises, goodwill, and knowledge resources, such as data center asset 244 documentation. Yet other examples of intangible data center assets 244 may include certain tasks, functions, operations, procedures, or processes performed by data center personnel. Those of skill in the art will recognize that many such examples of tangible and intangible data center assets 244 are possible. Accordingly, the foregoing is not intended to limit the spirit, scope or intent of the invention.

In certain embodiments, the value produced by a data center asset 244 may be tangible or intangible. As used herein, tangible value broadly refers to value that can be measured. Examples of tangible value may include return on investment (ROI), total cost of ownership (TCO), internal rate of return (IRR), increased performance, more efficient use of resources, improvement in sales, decreased customer support costs, and so forth. As likewise used herein, intangible value broadly refers to value that provides a benefit that may be difficult to measure. Examples of intangible value may include improvements in user experience, customer support, and market perception. Skilled practitioners of the art will recognize that many such examples of tangible and intangible value are possible. Accordingly, the foregoing is not intended to limit the spirit, scope or intent of the invention.

In certain embodiments, the data center monitoring and management environment 200 may include a data center monitoring and management console 118. In certain embodiments, the data center monitoring and management console 118 may be implemented to perform a data center monitoring and management operation. As used herein, a data center monitoring and management operation broadly refers to any task, function, operation, procedure, or process performed, directly or indirectly, within a data center monitoring and management environment 200 to procure, deploy, configure, implement, operate, monitor, manage, maintain, or remediate a data center asset 244.

In certain embodiments, a data center monitoring and management operation may include a data center monitoring task. As used herein, a data center monitoring task broadly refers to any function, operation, procedure, or process performed, directly or indirectly, within a data center monitoring and management environment 200 to monitor the operational status of a particular data center asset 244. In various embodiments, a particular data center asset 244 may be implemented to generate an alert if its operational status exceeds certain parameters. In these embodiments, the definition of such parameters, and the method by which they may be selected, is a matter of design choice.

For example, an internal cooling fan of a server may begin to fail, which in turn may cause the operational temperature of the server to exceed its rated level. In this example, the server may be implemented to generate an alert, which provides notification of the occurrence of a data center issue. As used herein, a data center issue broadly refers to an operational situation associated with a particular component of a data center monitoring and management environment 200, which if not corrected, may result in negative consequences. In certain embodiments, a data center issue may be related to the occurrence, or predicted occurrence, of an anomaly within the data center monitoring and management environment 200. In certain embodiments, the anomaly may be related to unusual or unexpected behavior of one or more data center assets 244.

In certain embodiments, a data center monitoring and management operation may include a data center management task. As used herein, a data center management task broadly refers to any function, operation, procedure, or process performed, directly or indirectly, within a data center monitoring and management environment 200 to manage a particular data center asset 244. In certain embodiments, a data center management task may include a data center deployment operation, a data center remediation operation, a data center remediation documentation operation, a connectivity management operation, or a combination thereof.

As used herein, a data center deployment operation broadly refers to any function, task, procedure, or process performed, directly or indirectly, within a data center monitoring and management environment 200 to install a software file, such as a configuration file, a new software application, a version of an operating system, and so forth, on a data center asset 244. As likewise used herein, a data center remediation operation broadly refers to any function, task, procedure, or process performed, directly or indirectly, within a data center monitoring and management environment 200 to correct an operational situation associated with a component of a data center monitoring and management environment 200, which if not corrected, may result in negative consequences. A data center remediation documentation operation, as likewise used herein, broadly refers to any function, task, procedure, or process performed, directly or indirectly, within a data center monitoring and management environment 200 to retrieve, generate, revise, update, or store remediation documentation that may be used in the performance of a data center remediation operation.

Likewise, as used herein, a connectivity management operation (also referred to as a data center connectivity management operation) broadly refers to any task, function, procedure, or process performed, directly or indirectly, to manage connectivity between a particular data center asset 244 and a particular data center monitoring and management console 118. In various embodiments, one or more connectivity management operation may be performed to ensure that data exchanged between a particular data center asset 244 and a particular data center monitoring and management console 118 during a communication session is secured. In certain of these embodiments, as described in greater detail herein, various cryptographic approaches familiar to skilled practitioners of the art may be used to secure a particular communication session.

In certain embodiments, the data center monitoring and management console 118 may be implemented to receive an alert corresponding to a particular data center issue. In various embodiments, the data center monitoring and management console 118 may be implemented to receive certain data associated with the operation of a particular data center asset 244. In certain embodiments, such operational data may be received through the use of telemetry approaches familiar to those of skill in the art. In various embodiments, the data center monitoring console 118 may be implemented to process certain operational data received from a particular data center asset to determine whether a data center issue has occurred, is occurring, or is anticipated to occur.

In certain embodiments, the data center monitoring and management console 118 may be implemented to include a monitoring module 120, a management monitor 122, an analysis engine 124, and a connectivity management system (CMS) 126, a utilization management system 130, or a combination thereof. In certain embodiments, the monitoring module 120 may be implemented to monitor the procurement, deployment, implementation, operation, management, maintenance, or remediation of a particular data center asset 244 at any point in its lifecycle. In certain embodiments, the management module 122 may be implemented to manage the procurement, deployment, implementation, operation, monitoring, maintenance, or remediation of a particular data center asset 244 at any point in its lifecycle.

In various embodiments, the monitoring module 120, the management module 122, the analysis engine 124, CMS 126, and the utilization management system 130, may be implemented, individually or in combination with one another, to perform a data center asset monitoring and management operation, as likewise described in greater detail herein. In various embodiments, a CMS client 136 may be implemented on certain user devices 204, or certain data center assets 244, or a combination thereof. In various embodiments, the CMS 126 may be implemented in combination with a particular CMS client 136 to perform a connectivity management operation, as described in greater detail herein. In various embodiments, the CMS 126 may likewise be implemented in combination with the utilization management system 130 to perform a data center monitoring and management operation, described in greater detail herein. In certain embodiments, a data center monitoring and management operation may be implemented to include one or more utilization management operations, likewise described in greater detail herein.

In certain embodiments, the data center monitoring and management environment 200 may include a repository of data center monitoring and management data 220. In certain embodiments, the repository of data center monitoring and management data 220 may be local to the information handling system 100 executing the data center monitoring and management console 118 or may be located remotely. In various embodiments, the repository of data center monitoring and management data 220 may include certain information associated with data center asset data 220, data center asset configuration rules 224, data center infrastructure data 226, data center remediation data 228, and data center personnel data 230.

As used herein, a data center asset data 222 broadly refers to information associated with a particular data center asset 244, such as an information handling system 100, or an associated workload, that can be read, measured, and structured into a usable format. For example, data center asset data 222 associated with a particular server may include the number and type of processors it can support, their speed and architecture, minimum and maximum amounts of memory supported, various storage configurations, the number, type, and speed of input/output channels and ports, and so forth. In various embodiments, the data center asset data 222 may likewise include certain performance and configuration information associated with a particular workload, as described in greater detail herein. In various embodiments, the data center asset data 222 may include certain public or proprietary information related to data center asset 244 configurations associated with a particular workload.

In certain embodiments, the data center asset data 222 may include information associated with data center asset 244 types, quantities, locations, use types, optimization types, workloads, performance, support information, and cost factors, or a combination thereof, as described in greater detail herein. In certain embodiments, the data center asset data 222 may include information associated with data center asset 244 utilization patterns, likewise described in greater detail herein. In certain embodiments, the data center asset data 222 may include information associated with the allocation of certain data center asset resources, described in greater detail herein, to a particular workload.

As likewise used herein, a data center asset configuration rule 224 broadly refers to a rule used to configure a particular data center asset 244. In certain embodiments, one or more data center asset configuration rules 224 may be used to verify that a particular data center asset 244 configuration is the most optimal for an associated location, or workload, or to interact with other data center assets 244, or a combination thereof, as described in greater detail herein. In certain embodiments, the data center asset configuration rule 224 may be used in the performance of a data center asset configuration verification operation, a data center remediation operation, or a combination of the two. In certain embodiments, the data center asset configuration verification operation, or the data center remediation operation, or both, may be performed by an asset configuration system 250. In certain embodiments, the asset configuration system 250 may be used in combination with the data center monitoring and management console 118 to perform a data center asset configuration operation, or a data center remediation operation, or a combination of the two.

As used herein, data center infrastructure 226 data broadly refers to any data associated with a data center infrastructure component. As likewise used herein, a data center infrastructure component broadly refers to any component of a data center monitoring and management environment 200 that may be involved, directly or indirectly, in the procurement, deployment, implementation, configuration, operation, monitoring, management, maintenance, or remediation of a particular data center asset 244. In certain embodiments, data center infrastructure components may include physical structures, such as buildings, equipment racks and enclosures, network and electrical cabling, heating, cooling, and ventilation (HVAC) equipment and associated ductwork, electrical transformers and power conditioning systems, water pumps and piping systems, smoke and fire suppression systems, physical security systems and associated peripherals, and so forth. In various embodiments, data center infrastructure components may likewise include the provision of certain services, such as network connectivity, conditioned airflow, electrical power, and water, or a combination thereof.

Data center remediation data 228, as used herein, broadly refers to any data associated with the performance of a data center remediation operation, described in greater detail herein. In certain embodiments, the data center remediation data 228 may include information associated with the remediation of a particular data center issue, such as the date and time an alert was received indicating the occurrence of the data center issue. In certain embodiments, the data center remediation data 228 may likewise include the amount of elapsed time before a corresponding data center remediation operation was begun after receiving the alert, and the amount of elapsed time before it was completed. In various embodiments, the data center remediation data 228 may include information related to certain data center issues, the frequency of their occurrence, their respective causes, error codes associated with such data center issues, the respective location of each data center asset 244 associated with such data center issues, and so forth.

In various embodiments, the data center remediation data 228 may include information associated with data center asset 244 replacement parts, or upgrades, or certain third party services that may need to be procured in order to perform the data center remediation operation. Likewise, in certain embodiments, related data center remediation data 228 may include the amount of elapsed time before the replacement parts, or data center asset 244 upgrades, or third party services were received and implemented. In certain embodiments, the data center remediation data 228 may include information associated with data center personnel who may have performed a particular data center remediation operation. Likewise, in certain embodiments, related data center remediation data 228 may include the amount of time the data center personnel actually spent performing the operation, issues encountered in performing the operation, and the eventual outcome of the operation that was performed.

In certain embodiments, the data center remediation data 228 may include remediation documentation associated with performing a data center asset remediation operation associated with a particular data center asset 244. In various embodiments, such remediation documentation may include information associated with certain attributes, features, characteristics, functional capabilities, operational parameters, and so forth, of a particular data center asset 244. In certain embodiments, such remediation documentation may likewise include information, such as step-by-step procedures and associated instructions, video tutorials, diagnostic routines and tests, checklists, and so forth, associated with remediating a particular data center issue.

In certain embodiments, the data center remediation data 228 may include information associated with any related remediation dependencies, such as other data center remediation operations that may need to be performed beforehand. In certain embodiments, the data center remediation data 228 may include certain time restrictions when a data center remediation operation, such as rebooting a particular server, may be performed. In various embodiments, the data center remediation data 228 may likewise include certain autonomous remediation rules, described in greater detail herein. In various embodiments, certain of these autonomous remediation rules may be used in the performance of an autonomous remediation operation, described in greater detail herein. Those of skill in the art will recognize that many such examples of data center remediation data 228 are possible. Accordingly, the foregoing is not intended to limit the spirit, scope, or intent of the invention.

Data center personnel data 230, as used herein, broadly refers to any data associated with data center personnel who may be directly, or indirectly, involved in the procurement, deployment, configuration, implementation, operation, monitoring, management, maintenance, or remediation of a particular data center asset 244. In various embodiments, the data center personnel data 230 may include job title, work assignment, or responsibility information corresponding to certain data center personnel. In various embodiments, the data center personnel data 230 may include information related to the type, and number, of data center remediation operations currently being, or previously performed by certain data center personnel. In various embodiments, the data center personnel data 230 may include historical information, such as success metrics, associated with data center remediation operations performed by certain data center personnel, such as data center administrators, operators, and technicians. In these embodiments, the data center personnel data 230 may be updated as individual data center personnel complete each data center remediation task they are assigned, described in greater detail herein.

In various embodiments, the data center personnel data 230 may likewise include education, certification, and skill level information corresponding to certain data center personnel. Likewise, in various embodiments, the data center personnel data 230 may include security-related information, such as security clearances, user IDs, passwords, security-related biometrics, authorizations, and so forth, corresponding to certain data center personnel. Those of skill in the art will recognize that many such examples of data center personnel data 230 are possible. Accordingly, the foregoing is not intended to limit the spirit, scope, or intent of the invention.

In certain embodiments, various data center assets 244 within a data center monitoring and management environment 200 may have certain interdependencies. As an example, a data center monitoring and management environment 200 may have multiple servers interconnected by a storage area network (SAN) providing block-level access to various disk arrays and tape libraries. In this example, the servers, various physical and operational elements of the SAN, as well as the disk arrays and tape libraries, are interdependent upon one another.

In certain embodiments, each data center asset 244 in a data center monitoring and management environment 200 may be treated as a separate data center asset 244 and depreciated individually according to their respective attributes. As an example, a particular rack of servers in a data center monitoring and management environment 200 may be made up of a variety of individual servers, each of which may have a different depreciation schedule. To continue the example, certain of these data center assets 244 may be implemented in different combinations to produce an end result. To further illustrate the example, a particular server in the rack of servers may initially be implemented to query a database of customer records. As another example, the same server may be implemented at a later time to perform an analysis of sales associated with those same customer records.

In certain embodiments, each data center asset 244 in a data center monitoring and management environment 200 may have an associated maintenance schedule and service contract. For example, a data center monitoring and management environment 200 may include a wide variety of servers and storage arrays, which may respectively be manufactured by a variety of manufacturers. In this example, the frequency and nature of scheduled maintenance, as well as service contract terms and conditions, may be different for each server and storage array. In certain embodiments, the individual data center assets 244 in a data center monitoring and management environment 200 may be configured differently, according to their intended use. To continue the previous example, various servers may be configured with faster or additional processors for one intended workload, while other servers may be configured with additional memory for other intended workloads. Likewise, certain storage arrays may be configured as one RAID configuration, while others may be configured as a different RAID configuration.

In certain embodiments, the data center monitoring and management environment 200 may likewise be implemented to include an asset configuration system 250, a product configuration system 252, a product fabrication system 254, and a supply chain system 256, or a combination thereof. In various embodiments, the asset configuration system 250 may be implemented to perform certain data center asset 244 configuration operations. In certain embodiments, the data center asset 244 configuration operation may be performed to configure a particular data center asset 244 for a particular purpose. In certain embodiments, the data center monitoring and management console 118 may be implemented to interact with the asset configuration system 250 to perform a particular data center asset 244 configuration operation. In various embodiments, the asset configuration system 250 may be implemented to generate, manage, and provide, or some combination thereof, data center asset configuration rules 224. In certain of these embodiments, the data center asset configuration rules 224 may be used to configure a particular data center asset 244 for a particular purpose.

In certain embodiments, a user 202 may use a user device 204 to interact with the data center monitoring and management console 118. As used herein, a user device 204 refers to an information handling system such as a personal computer, a laptop computer, a tablet computer, a personal digital assistant (PDA), a smart phone, a mobile telephone, or other device that is capable of processing and communicating data. In certain embodiments, the communication of the data may take place in real-time or near-real-time. As used herein, real-time broadly refers to processing and providing information within a time interval brief enough to not be discernable by a user 202.

In certain embodiments, a user device 204 may be implemented with a camera 206, such as a video camera known to skilled practitioners of the art. In certain embodiments, the camera 206 may be integrated into the user device 204. In certain embodiments, the camera 206 may be implemented as a separate device configured to interoperate with the user device 204. As an example, a webcam familiar to those of skill in the art may be implemented to receive and communicate various image and audio signals to a user device 204 via a Universal Serial Bus (USB) interface. In certain embodiments, the user device 204 may be configured to present a data center monitoring and management console user interface (UI) 240. In certain embodiments, the data center monitoring and management console UI 240 may be implemented to present a graphical representation 242 of data center asset monitoring and management information, which is automatically generated in response to interaction with the data center monitoring and management console 118.

In certain embodiments, a data center monitoring and management application 238 may be implemented on a particular user device 204. In various embodiments, the data center monitoring and management application 238 may be implemented on a mobile user device 204, such as a laptop computer, a tablet computer, a smart phone, a dedicated-purpose mobile device, and so forth. In certain of these embodiments, the mobile user device 204 may be used at various locations within the data center monitoring and management environment 200 by the user 202 when performing a data center monitoring and management operation, described in greater detail herein.

In various embodiments, the data center monitoring and management application 238 may be implemented to facilitate a user 202, such as a data center administrator, operator, or technician, to perform a particular data center remediation operation. In various embodiments, such facilitation may include using the data center monitoring and management application 238 to receive a notification of a data center remediation task, described in greater detail herein, being assigned to the user. In certain embodiments, the data center monitoring and management console 118 may be implemented to generate the notification of the data center remediation task assignment, and assign it to the user, as likewise described in greater detail herein. In certain embodiments, the data center monitoring and management console 118 may be implemented to generate the data center remediation task, and once generated, provide it to the data center monitoring and management application 238 associated with the assigned user 202.

In certain embodiments, such facilitation may include using the data center monitoring and management application 238 to receive the data center remediation task from the data center monitoring and management console 118. In various embodiments, such facilitation may include using the data center monitoring and management application 238 to confirm that the user 202 is at the correct physical location of a particular data center asset 244 associated with a corresponding data center issue. In certain of these embodiments, the data center monitoring and management application 238 may be implemented to include certain Global Positioning System (GPS) capabilities, familiar to those of skill in the art, which may be used to determine the physical location of the user 202 in relation to the physical location of a particular data center asset 244.

In various embodiments, such facilitation may include using the data center monitoring and management application 238 to ensure the user 202 is aware of, or is provided the location of, or receives, or a combination thereof, certain remediation resources, described in greater detail herein, that may be needed to perform a particular data center remediation operation. In various embodiments, such facilitation may include using the data center monitoring and management application 238 to view certain remediation documentation, or augmented instructions, related to performing a particular data center remediation operation. In various embodiments, such facilitation may include using the data center monitoring and management application 238 to certify that a particular data center remediation operation has been performed successfully.

In certain embodiments the UI window 240 may be implemented as a UI window of the data center monitoring and management application 238. In various embodiments, the data center monitoring and management application 238 may be implemented to include, in part or in whole, certain functionalities associated with the data center monitoring and management console 118. In certain embodiments, the data center monitoring and management application 238 may be implemented to interact in combination with the data center monitoring and management console 118, and other components of the data center monitoring and management environment 200, to perform a data center monitoring and management operation.

In certain embodiments, the user device 204 may be used to exchange information between the user 202 and the data center monitoring and management console 118, the data center monitoring and management application 238, the asset configuration system 250, the product configuration system 252, the product fabrication system 254, and the supply chain system 256, or a combination thereof, through the use of a network 140. In various embodiments, the asset configuration system 250 may be implemented to configure a particular data center asset 244 to meet certain performance goals. In various embodiments, the asset configuration system 250 may be implemented to use certain data center monitoring and management data 220, certain data center asset configuration rules 226 it may generate or manage, or a combination thereof, to perform such configurations.

In various embodiments, the product configuration system 252 may be implemented to use certain data center monitoring and management data 220 to optimally configure a particular data center asset 244, such as a server, for an intended workload. In various embodiments, the data center monitoring and management data 220 used by the product configuration system 252 may have been generated as a result of certain data center monitoring and management operations, described in greater detail herein, being performed by the data center monitoring and management console 118. In various embodiments, the product configuration system 252 may be implemented to provide certain product configuration information to a product fabrication system 254. In various embodiments, the product fabrication system 254 may be implemented to provide certain product fabrication information to a product fabrication environment (not shown). In certain embodiments, the product fabrication information may be used by the product fabrication environment to fabricate a product, such as a server, to match a particular data center asset 244 configuration.

In various embodiments, the data center monitoring and management console UI 240 may be presented via a website (not shown). In certain embodiments, the website may be provided by one or more of the data center monitoring and management console 118, the asset configuration system 250, the product configuration system 252, the product fabrication system 254, or the supply chain system 256. In certain embodiments, the supply chain system 256 may be implemented to manage the provision, fulfillment, or deployment of a particular data center asset 244 produced in the product fabrication environment. For the purposes of this disclosure, a website may be defined as a collection of related web pages which are identified with a common domain name and is published on at least one web server. A website may be accessible via a public IP network or a private local network.

A web page is a document which is accessible via a browser which displays the web page via a display device of an information handling system. In various embodiments, the web page also includes the file which causes the document to be presented via the browser. In various embodiments, the web page may comprise a static web page, which is delivered exactly as stored and a dynamic web page, which is generated by a web application that is driven by software that enhances the web page via user input 208 to a web server.

In certain embodiments, the data center monitoring and management console 118 may be implemented to interact with the asset configuration system 250, the product configuration system 252, the product fabrication system 254, and the supply chain or fulfillment system 256, or a combination thereof, each of which in turn may be executing on a separate information handling system 100. In certain embodiments, the data center monitoring and management console 118 may be implemented to interact with the asset configuration system 250, the product configuration system 252, the product fabrication system 254, and the supply chain or fulfillment system 256, or a combination thereof, to perform a data center monitoring and management operation, as described in greater detail herein.

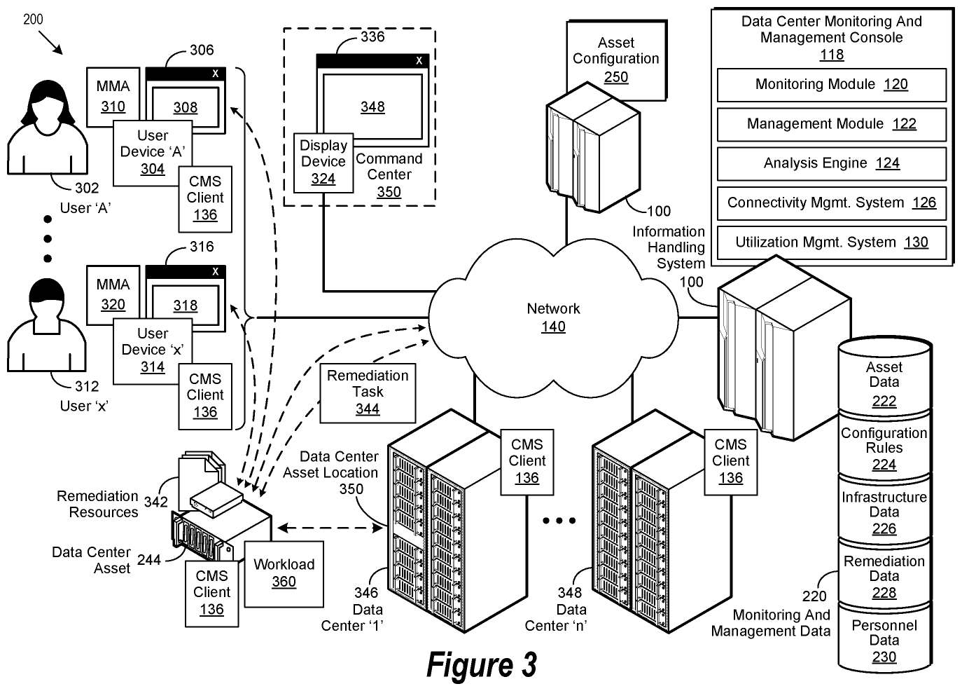

FIG. 3 shows a functional block diagram of the performance of certain data center monitoring and management operations implemented in accordance with an embodiment of the invention. In various embodiments, a data center monitoring and management environment 200, described in greater detail herein, may be implemented to include one or more data centers, such as data centers ‘1’ 346 through ‘n’ 348. As likewise described in greater detail herein, each of the data centers ‘1’ 346 through ‘n’ 348 may be implemented to include one or more data center assets 244, likewise described in greater detail herein.

In certain embodiments, a data center asset 244 may be implemented to process an associated workload 360. A workload 360, as used herein, broadly refers to a measure of information processing that can be performed by one or more data center assets 244, individually or in combination with one another, within a data center monitoring and management environment 200. In certain embodiments, a workload 360 may be implemented to be processed in a virtual machine (VM) environment, familiar to skilled practitioners of the art. In various embodiments, a workload 360 may be implemented to be processed as a containerized workload 360, likewise familiar to those of skill in the art.

In certain embodiments, as described in greater detail herein, the data center monitoring and management environment 200 may be implemented to include a data center monitoring and management console 118. In certain embodiments, the data center monitoring and management console 118 may be implemented to include a monitoring module 120, a management module 122, an analysis engine 124, and a connectivity management system (CMS) 126, and a utilization management system 130, or a combination thereof, as described in greater detail herein. In various embodiments, a CMS client 136, described in greater detail herein may be implemented on certain user devices ‘A’ 304 through ‘x’ 314, or certain data center assets 244, or within data centers ‘1’ 346 through ‘n’ 348, or a combination thereof. In certain embodiments, the CMS 126 may be implemented in combination with a particular CMS client 136 to perform a connectivity management operation, as likewise described in greater detail herein.

As described in greater detail herein, the data center monitoring and management console 118 may be implemented in certain embodiments to perform a data center monitoring and management operation. In certain embodiments, the data center monitoring and management console 118 may be implemented to provide a unified framework for the performance of a plurality of data center monitoring and management operations, by a plurality of users, within a common user interface (UI). In certain embodiments, the data center monitoring and management console 118, and other components of the data center monitoring environment 200, such as the asset configuration system 250, may be implemented to be used by a plurality of users, such as users ‘A’ 302 through ‘x’ 312 shown in FIG. 3. In various embodiments, certain data center personnel, such as users ‘A’ 302 through ‘x’ 312, may respectively interact with the data center monitoring and management console 118, and other components of the data center monitoring and management environment 200, through the use of an associated user device ‘A’ 304 through ‘x’ 314.

In certain embodiments, such interactions may be respectively presented to users ‘A’ 302 through ‘x’ 312 within a user interface (UI) window 306 through 316, corresponding to user devices ‘A’ 304 through ‘x’ 314. In certain embodiments the UI window 306 through 316 may be implemented in a window of a web browser, familiar to skilled practitioners of the art. In certain embodiments, a data center monitoring and management application (MMA) 310 through 320, described in greater detail herein, may be respectively implemented on user devices ‘A’ 304 through ‘x’ 314. In certain embodiments, the UI window 306 through 316 may be respectively implemented as a UI window of the data center MMA 310 through 320. In certain embodiments, the data center MMA 310 through 320 may be implemented to interact in combination with the data center monitoring and management console 118, and other components of the data center monitoring and management environment 200, to perform a data center monitoring and management operation. In various embodiments, performance of the data center monitoring and management operation may include the performance of one or more utilization management operations, or one or more workload management operations, or a combination thereof, as described in greater detail herein.

In certain embodiments, the interactions with the data center monitoring and management console 118, and other components of the data center monitoring and management environment 200, may respectively be presented as a graphical representation 308 through 318 within UI windows 306 through 316. In various embodiments, such interactions may be presented to users ‘A’ 302 through ‘x’ 312 via a display device 324, such as a projector or large display screen. In certain of these embodiments, the interactions may be presented to users ‘A’ 302 through ‘x’ 312 as a graphical representation 348 within a UI window 336.

In certain embodiments, the display device 324 may be implemented in a command center 350, familiar to those of skill in the art, such as a command center 350 typically found in a data center or a network operations center (NOC). In various embodiments, one or more of the users ‘A’ 302 through ‘x’ 312 may be located within the command center 350. In certain of these embodiments, the display device 324 may be implemented to be generally viewable by one or more of the users ‘A’ 302 through ‘x’ 312.

In certain embodiments, the data center monitoring and management operation may be performed to identify the location 350 of a particular data center asset 244. In certain embodiments, the location 350 of a data center asset 244 may be physical, such as the physical address of its associated data center, a particular room in a building at the physical address, a particular location in an equipment rack in that room, and so forth. In certain embodiments, the location 350 of a data center asset 244 may be non-physical, such as a network address, a domain, a Uniform Resource Locator (URL), a file name in a directory, and so forth.

Certain embodiments of the invention reflect an appreciation that it is not uncommon for large organization to have one or more data centers, such as data centers ‘1’ 346 through ‘n’ 348. Certain embodiments of the invention reflect an appreciation that it is likewise not uncommon for such data centers to have multiple data center system administrators and data center technicians. Likewise, various embodiments of the invention reflect an appreciation that it is common for a data center system administrator to be responsible for planning, initiating, and overseeing the execution of certain data center monitoring and management operations. Certain embodiments of the invention reflect an appreciation that it is common for a data center system administrator, such as user ‘A’ 302, to assign a particular data center monitoring and management operation to a data center technician, such as user ‘x’ 312, as a task to be executed.

Certain embodiments of the invention reflect an appreciation that it is likewise common for a data center administrator, such as user ‘A’ 302, to assume responsibility for performing a particular data center monitoring and management operation. As an example, a data center administrator may receive a stream of data center alerts, each of which is respectively associated with one or more data center issues. To continue the example, several of the alerts may have an initial priority classification of “critical.” However, the administrator may notice that one such alert may be associated with a data center issue that is more critical, or time sensitive, than the others and should be remediated as quickly as possible. Accordingly, the data center administrator may elect to assume responsibility for remediating the data center issue, and as a result, proceed to perform an associated data center remediation operation at that time instead of assigning it to other data center personnel.

Certain embodiments of the invention reflect an appreciation that the number of data center assets 244 in a particular data center ‘1’ 346 through ‘n’ 348 may be quite large. Furthermore, it is not unusual for such data center assets 244 to be procured, deployed, configured, and implemented on a scheduled, or as needed, basis. It is likewise common for certain existing data center assets 244 to be replaced, upgraded, reconfigured, maintained, or remediated on a scheduled, or as-needed, basis. Likewise, certain embodiments of the invention reflect an appreciation that such replacements, upgrades, reconfigurations, maintenance, or remediation may be oriented towards hardware, firmware, software, connectivity, or a combination thereof.

For example, a data center system administrator may be responsible for the creation of data center asset 244 procurement, deployment, configuration, and implementation templates, firmware update bundles, operating system (OS) and software application stacks, and so forth. Likewise, a data center technician may be responsible for receiving a procured data center asset 244, transporting it to a particular data asset location 350 in a particular data center ‘1’ 346 through ‘n’ 348, and implementing it in that location 350. The same, or another, data center technician may then be responsible for configuring the data center asset 244, establishing network connectivity, applying configuration files, and so forth. To continue the example, the same, or another, data center administrator or technician may be responsible for remediating hardware issues, such as replacing a disc drive in a server or Redundant Array of Independent Disks (RAID) array, or software issues, such as updating a hardware driver or the version of a server's operating system. Accordingly, certain embodiments of the invention reflect an appreciation that a significant amount of coordination may be needed between data center system administrators and data center technicians to assure efficient and reliable operation of a data center.

In various embodiments, certain data center monitoring and management operations may include a data center remediation operation, described in greater detail herein. In certain embodiments, a data center remediation operation may be performed to remediate a particular data asset 244 issue at a particular data asset location 350 in a particular data center ‘1’ 346 through ‘n’ 348. In certain embodiments, the data center remediation operation may be performed to ensure that a particular data center asset location 350 in a particular data center ‘1’ 346 through ‘n’ 348 is available for the replacement or upgrade of an existing data center asset 244. As an example, a data center remediation operation may involve deployment of a replacement server that occupies more rack space than the server it will be replacing.

In various embodiments, the data center monitoring and management console 118, or the data center monitoring and management application 310 through 320, or a combination of the two, may be implemented in a failure tracking mode to capture certain data center asset 244 telemetry. In various embodiments, the data center asset 244 telemetry may include data associated with the occurrence of certain events, such as the failure, or anomalous performance, of a particular data center asset 244, or an associated workload 360, in whole, or in part. In certain embodiments, the data center asset 244 telemetry may be captured incrementally to provide a historical perspective of the occurrence, and evolution, of an associated data center issue.

In various embodiments, the data center monitoring and management console 118 may likewise be implemented to generate certain remediation operation notes. For example, the data center monitoring and management console 118 may enter certain data center asset 244 remediation instructions in the data center remediation operation notes. In various embodiments, the data center remediation operation notes may be implemented to contain information related to data center asset 244 replacement or upgrade parts, data center asset 244 files that may be needed, installation and configuration instructions related to such files, the physical location 350 of the data center asset 244, and so forth. In certain embodiments, a remediation task 344 may be generated by associating the previously-generated data center remediation operation notes with the remediation documentation, data center asset files, or other remediation resources 342 most pertinent to the data center issue, and the administrator, and any data center personnel selected or its remediation. As used herein, a data center remediation task 344 broadly refers to one or more data center remediation operations, described in greater detail herein, that can be assigned to one or more users ‘A’ 302 through ‘x’ 312.

Certain embodiments of the invention reflect an appreciation that a group of data center personnel, such as users ‘A’ 302 through ‘x’ 312, will likely possess different skills, certifications, levels of education, knowledge, experience, and so forth. As a result, remediation documentation that is suitable for certain data center personnel may not be suitable for others. For example, a relatively inexperienced data center administrator may be overwhelmed by a massive volume of detailed and somewhat arcane minutiae related to the configuration and administration of multiple virtual machines (VMs) on a large server. However, such remediation documentation may be exactly what a highly skilled and experienced data center administrator needs to remediate subtle server and VM configuration issues.

Conversely, the same highly skilled and experienced data center administrator may be hampered, or slowed down, by being provided remediation documentation that is too simplistic, generalized, or high-level for the data center issue they may be attempting to remediate. Likewise, an administrator who is moderately skilled in configuring VMs may benefit from having step-by-step instructions, and corresponding checklists, when remediating a VM-related data center issue. Accordingly, as used herein, pertinent remediation documentation broadly refers to remediation documentation applicable to a corresponding data center issue that is most suited to the skills, certifications, level of education, knowledge, experience, and so forth of the data center personnel assigned to its remediation.

In various embodiments, the data center monitoring and management console 118 may be implemented to generate a corresponding notification of the remediation task 344. In certain embodiments, the resulting notification of the remediation task 344 assignment may be provided to the one or more users ‘A’ 302 through ‘x’ 312 assigned to perform the remediation task 344. In certain embodiments, the notification of the remediation task 344 assignment may be respectively provided to the one or more users ‘A’ 302 through ‘x’ 312 within the UI 306 through 316 of their respective user devices ‘A’ 304 through ‘x’ 314. In certain embodiments, the notification of the remediation task 344 assignment, and the remediation task 344 itself, may be implemented such that they are only visible to the users ‘A’ 302 through ‘x’ 312 to which it is assigned.

In certain embodiments, the data center monitoring and management console 118 may be implemented to operate in a monitoring mode. As used herein, monitoring mode broadly refers to a mode of operation where certain monitoring information provided by the monitoring and management console 118 is available for use by one or more users ‘A’ 302 through ‘x’ 312. In certain embodiments, one or more of the users ‘A’ 302 through ‘x’ 312 may be command center 350 users. In certain embodiments, the data center monitoring and management console 118 may be implemented to operate in a management mode. As used herein, management mode broadly refers to a mode of operation where certain operational functionality of the data center monitoring and management console 118 is available for use by a user, such as users ‘A’ 302 through ‘x’ 312.

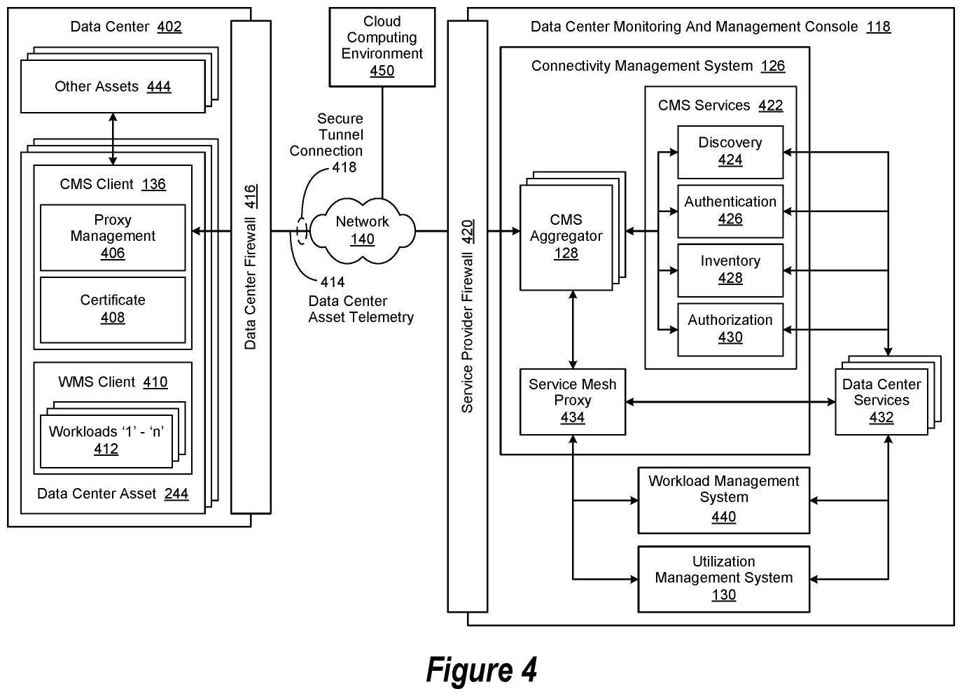

FIG. 4 shows a block diagram of a data center monitoring and management console implemented in accordance with an embodiment of the invention. In various embodiments, the data center monitoring and management console 118, described in greater detail herein, may be implemented to include a connectivity management system (CMS) 126, a utilization management system 130, a workload management system (WMS) 440, and one or more data center services 432, or a combination thereof. In various embodiments, the CMS 126 may be implemented individually, or in combination with a particular CMS client 136 to perform a connectivity management operation, likewise described in greater detail herein. In various embodiments, one or more connectivity management operations may be performed to initiate, and manage, secure, bi-directional, real-time connectivity between a data center monitoring and management console 118 and a particular data center asset 244, as described in greater detail herein.

In various embodiments, the utilization management system 130 may be implemented to perform one or more utilization management operations. As used herein, a utilization management operation broadly refers to any task, function, operation, procedure, or process performed to manage one or more aspects of the utilization of one or more data center assets 244, or one or more of their respective components, or a combination thereof, used to service a particular workload. In various embodiments, one or more utilization management operations may be performed within a cloud computing environment (CCE) 450. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, services, and so forth) that can be rapidly provisioned and released with minimal management effort or service provider interaction.

As likewise used herein, provisioning broadly refers to the process of making available, and configuring, one or more components of an information technology (IT) infrastructure for use, directly or indirectly, within a CCE 450. As such, various embodiments of the invention reflect an appreciation that such provisioning may include the performance of one or more utilization management operations to facilitate user and system access to various data center assets and associated resources. Various embodiments of the invention likewise reflect an appreciation that such provisioning may include the performance of multiple tasks and involve multiple systems, data center assets, and associated resources, or a combination thereof.

Those of skill in the art will be aware that cloud computing, as typically implemented, has certain characteristics, such as on-demand self-service. As a result, a user can unilaterally and automatically provision certain computing capabilities, such as server time and network storage, without requiring human interaction with each CCE 450. Another characteristic of cloud computing is broad network access, where certain cloud computing capabilities may be made available over a network connection and accessed through standard mechanisms that promote use by heterogeneous thin or thick client platforms (e.g., mobile phones, tablets, laptops, and workstations).

Yet another characteristic of cloud computing is resource pooling, where cloud computing resources are pooled to serve multiple users in a multi-tenant model, with different physical and virtual resources dynamically assigned and reassigned according to individual demand. One aspect of resource pooling is a sense of location independence in that the user generally has no control over, or knowledge of, the exact location of the provided resources. Yet still another characteristic of cloud computing is elasticity, where cloud computing capabilities and functionalities can be elastically provisioned and released, in some cases automatically, to rapidly scale outward and inward according to demand. As a result, the resources available for provisioning often appear to be unlimited, and furthermore, can be appropriated in any quantity, at any time.

Another characteristic of cloud computing is the ability to automatically control and optimize resource utilization by leveraging a metering capability at some level of abstraction appropriate to the type of service (e.g., storage, processing, bandwidth, and active user accounts). Accordingly, resource usage can be monitored, controlled, and reported, providing transparency for both the provider and the user of a particular service. In various embodiments, one or more utilization management operations may be performed to automate such resource utilization, and by extension, make it more efficient.

Various embodiments of the invention reflect an appreciation that cloud computing may be implemented to support various service models. One such cloud service model is Software as a Service (SaaS), which allows a user to use certain software applications running in a CCE 450. As typically implemented, the applications are accessible from various client devices through either a thin client interface, such as a web browser (e.g., web-based email), or an Application Program Interface (API). As such, the user does not manage or control the underlying cloud computing infrastructure including network, servers, operating systems, storage, or even individual application capabilities.

Another cloud service model is Platform as a Service (PaaS), which allows a user to deploy custom-created, or acquired, software applications that have been created through the use of programming languages, libraries, services, and tools supported by the cloud computing infrastructure. In a PaaS model, the user does not manage or control the underlying cloud computing infrastructure, including network, servers, operating systems, or storage, but may have control over the deployed applications and associated configuration settings. Yet another cloud service model is Infrastructure as a Service (IaaS), which provides a user the ability to provision processing, storage, network connectivity, and other fundamental computing resources to implement and run one or more workloads 412 ‘1’ through ‘n’. As in other cloud service models, the user does not manage or control the underlying cloud computing infrastructure, but has control over operating systems, storage, and deployed applications; and possibly limited control of certain networking components (e.g., host firewalls).

In various embodiments, a CCE 450 may be implemented as a private, public, or hybrid CCE 450. As used herein, a private CCE 450 broadly refers to a cloud computing infrastructure provisioned for exclusive use by a single organization comprising multiple consumers (e.g., business units, departments, individual users, etc.). As such, it may be owned, managed, and operated by the organization, a third party, or some combination of the two, and it may exist on or off premises.

As likewise used herein, a community CCE 450 broadly refers to a cloud computing infrastructure provisioned for exclusive use by a specific community, or set, of users from organizations that have shared interests or objectives (e.g., their common mission, security requirements, policy, compliance considerations, etc.). Accordingly, it may be owned, managed, and operated by one or more of the organizations that are a member of the community, a third party, or some combination thereof, and it may exist on or off premises. Likewise, as used herein, a public CCE 450 broadly refers to a cloud computing infrastructure that is provisioned for open use by the general public. It may be owned, managed, and operated by a business, academic, government organization, or non-government organization, or some combination thereof, but it exists on the premises of the cloud computing provider, whoever they may be. Examples of such public CCEs 450 include Amazon Web Services (AWS®), Oracle® Cloud Platform, Microsoft® Azure®, and others.

A hybrid CCE 450, as used herein, broadly refers to a CCE 450 that is a composition of two or more distinct CCEs 450 (e.g., private, community, or public) that remain unique and separate entities, but are bound together by standardized or proprietary technology that enables data and application portability (e.g., cloud bursting for load balancing between clouds). In certain embodiments, a hybrid CCE 450 may be implemented by an organization that maintains one or more private CCEs 450 of its own, while likewise using one or more private, community, or public CCEs 450 provided by others. In various embodiments, certain multi cloud approaches may involve the use of two or more private, community, public, or hybrid CCEs 450, or a combination thereof. In various embodiments, one or more CCEs 450 may be implemented to include a data center monitoring and management environment.

Various embodiments of the invention reflect an appreciation that cloud-based services offered by commercial CCE 450 providers are often structured in tiers. Certain embodiments of the invention likewise reflect an appreciation that individual offerings within such service tiers typically correspond to the data center assets, or components thereof, utilized to service a particular workload, as well as their attendant cost to the customer. As an example, a standard, online data storage service that supports frequent access to short-lived data may require the allocation of significant, high performance data center assets, which may in turn come at a high cost point.

To continue the example, a nearline data storage service that supports infrequent access to moderately-lived data may require the allocation of fewer, lower performance data center assets, which may be offered at a lower cost tier. To further continue the example, a coldline data storage service that supports rarely accessed data may require the allocation of yet fewer, much lower performance data center assets, which may be offered at an even lower cost tier. To continue the example yet further, an archive data storage service that supports data archiving, online backup, and disaster recovery may require the allocation of a small number of lower performance data center assets, which may be offered at the lowest cost tier.

Various embodiments of the invention reflect an appreciation that a CCE 450 may service a wide variety of workloads, each of which may be supported by a wide range of data center assets, which in turn may respectively have performance and cost tradeoffs. Various embodiments of the invention likewise reflect an appreciation that currently-known CCE providers typically employ fairly simplistic and reactive approaches to this challenge. Examples of such approaches in Object Lifecycle Management (OLM) and Autoclass® in Google Cloud®, and Intelligent-Tiering® in Amazon Webb Services® (AWS) for demoting an object based upon its last operation.

However, various embodiments of the invention reflect an appreciation that historical operational behavior is often not an accurate predictor of the future. As an example, an application with seasonal behavior, such as salary payment performed on the first day of each month, or a sales promotion before a major holiday. Accordingly, certain embodiments of the invention reflect an appreciation that more sophisticated approaches may be warranted to forecast the future activity of workloads, and the data center assets used to service them.

In certain embodiments, the CMS 126, and the utilization management system 130, may likewise be implemented in combination with one another to perform a particular connectivity management operation, or a particular utilization management operation, or a combination of the two. In various embodiments, the data center monitoring and management console 118 may be implemented in a cloud environment familiar to skilled practitioners of the art. In various embodiments, the cloud environment may be distributed. In certain embodiments, such a distributed cloud environment may be implemented to include two or more data centers 402.

In certain embodiments, each data center 402 may be implemented to include one or more data center monitoring and management environments, described in greater detail herein. In various embodiments, each data center monitoring and management environment may be implemented to include one or more data center monitoring and management consoles 118. In certain of these embodiments, two or more data center monitoring and management consoles 118 may be implemented to operate in combination with one another to perform one or more data center monitoring and management operations, or one or more utilization management operations, or one or more workload management operations, or a combination thereof. In certain embodiments, a particular data center monitoring and management console 118 implemented in one data center monitoring and management environment may likewise be implemented to perform one or more data center monitoring and management operations, or one or more utilization management operations, or one or more workload management operations, or a combination thereof, within another data center monitoring and management environment.

In various embodiments, the connectivity management system 126 may be implemented to include one or more CMS aggregators 128, one or more CMS services 422, and a service mesh proxy 434, or a combination thereof. In various embodiments, the CMS aggregator 128 may be implemented to interact with one or more of the CMS services 422, as described in greater detail herein. In various embodiments, the data center services 432 may likewise be implemented to interact with one or more of the CMS services 422, and the service mesh proxy 434, or a combination thereof. In certain embodiments, the CMS services 422 may be implemented to include a CMS discovery 424 service, a CMS authentication 426 service, a CMS inventory 428 service, and a CMS authorization 430 service, or a combination thereof.

In certain embodiments, a data center 402 may be implemented to include an associated data center firewall 416. In certain embodiments, the operator of the data center monitoring and management console 118 may offer its various functionalities and capabilities in the form of one or more or more cloud-based data center services 432, described in greater detail herein. In certain of these embodiments, the data center 402 may reside on the premises of a user of one or more data center services 432 provided by the operator of the data center monitoring and management console 118.

In various embodiments, one or more data center assets 244, described in greater detail herein, may be implemented within a particular data center 402. In certain embodiments, individual data center assets 244 may be implemented to include a workload management system (WMS) client 410, or a CMS client 136, or both. As used herein, a workload management system (WMS) 410, broadly refers to any software, firmware, or hardware, of a combination thereof, that may be implemented to perform one or more WMS operations. As likewise used herein, a WMS operation broadly refers to any function, operation, procedure, or process performed, directly or indirectly, to forecast, plan, distribute, schedule, configure, initiate, manage, or monitor, or a combination thereof, one or more workloads 412 ‘1’ through ‘n’ such that they may be serviced by one or more data center assets 244.

One example of a WMS 410 is a hypervisor. Skilled practitioners of the art will be familiar with a hypervisor, also known as a virtual machine monitor (VMM), or virtualizer, which broadly refers to a type of computer software, firmware, or hardware, or a combination thereof, that can be implemented to create and run a virtual machine (VM). Those of skill in the art will likewise be familiar with a VM, which is a virtualization, or emulation, of a computer system that can be implemented to provide the functionality of a physical computer, or a particular capability thereof. In certain embodiments, a VM may be implemented in certain embodiments to service one or more workloads 412 ‘1’ through ‘n’.

Another example of a WMS 410 is a container orchestration system, such as the open source container orchestration system known as Kubernetes®. Skilled practitioners of the art will be familiar with container orchestration systems, which broadly refer to a type of computer software, firmware, or hardware, or a combination thereof, that can be implemented to automate the operational effort involved in running containerized workloads and services on one or more data center assets 244. Those of skill in the art will likewise be familiar with a container, which is a unit of software that packages computer code, and its dependencies, such that an associated software application is able to run quickly and reliably across one or more computing environments. In certain embodiments, a container orchestration system may be implemented in certain embodiments to orchestrate one or more containers as one or more workloads 412 ‘1’ through ‘n’. Skilled practitioners of the art will recognize that many such examples of a WMS 410 and an associated workload 412 ‘1’ through ‘n’ are possible. Accordingly, the foregoing is not intended to limit the spirit, scope, or intent of the invention.

In various embodiments, a CMS client 136 implemented on one data center asset 244 may likewise be implemented to enable one or more connectivity management operations, or one or more utilization management operations, or a combination thereof, associated with one or more other data center assets 444 that are not respectively implemented with their own CMS client 136. In certain of these embodiments, the CMS client 136 may be implemented to assume the identity, and attributes, of a particular data center asset it is directly, or indirectly, associated with. In various embodiments, the CMS client 136 may be implemented to convey certain utilization management operation information associated with a particular data center asset 244 that may be used to service a particular workload 412 ‘1’ through ‘n’, directly or indirectly, during a particular interval of time to the CMS aggregator 128.

In certain of these embodiments, the utilization management operation information may be conveyed as data center asset telemetry information 414 via a secure tunnel connection 418, described in greater detail herein, through a network 140 to a particular CMS aggregator 128. In certain embodiments, a CMS aggregator 128 may be implemented to provide such data center asset telemetry information 414 to the utilization management system 130, or the WMS 440, or both, either directly, or through a service mesh proxy 434, likewise described in greater detail herein. In various embodiments, a CMS aggregator 128 may be implemented to provide certain data center asset telemetry information 414 to the utilization management system 130, or the WMS 440, as one or more CMS services 422. In certain of these embodiments, one or more data center services 432 may be implemented to receive such data center asset telemetry information 414 from one or more CMS services 422 and then provide it to the utilization management system 130, or the WMS 440.

In various embodiments, the CMS client 136 may be implemented with a proxy management module 406. In certain of these embodiments, the proxy management module 406 may be implemented to manage the CMS client's 136 connectivity to an external network 140 through an intermediary proxy server, or the data center firewall 416, or both. Those of skill in the art will be familiar with a proxy server, which as typically implemented, is a server application that acts as an intermediary between a client, such as a web browser, requesting a resource, such as a web page, from a provider of that resource, such as a web server.

In certain embodiments, the client of a proxy server may be a particular data center asset 244 requesting a resource, such as a particular data center service 432, from the data center monitoring and management console 118. Skilled practitioners of the art will likewise be aware that in typical proxy server implementations, a client may direct a request to a proxy server, which evaluates the request and performs the network transactions needed to forward the request to a designated resource provider. Accordingly, the proxy server functions as a relay between the client and a server, and as such acts as an intermediary.

Those of skill in the art will be aware that proxy servers also assist in preventing an attacker from invading a private network, such as one implemented within a data center 402 to provide network connectivity to, and between, certain data center assets 244. Skilled practitioners of the art will likewise be aware that server proxies are often implemented in combination with a firewall, such as the data center firewall 416. In such implementations, the proxy server, due to it acting as an intermediary, effectively hides an internal network from the Internet, while the firewall prevents unauthorized access by blocking certain ports and programs.

Accordingly, a data center firewall 416 may be configured to allow traffic emanating from a proxy server to pass through to an external network 140, while blocking all other traffic from an internal network. Conversely, a firewall may likewise be configured to allow network 140 traffic emanating from a trusted source to pass through to an internal network, while blocking traffic from unknown or untrusted external sources. As an example, the data center firewall 416 may be configured in various embodiments to allow traffic emanating from the CMS client 136 to pass, while the service provider firewall 420 may be configured to allow traffic emanating from the CMS aggregator 128 to pass. Likewise, the service provider firewall 420 may be configured in various embodiments to allow incoming traffic emanating from the CMS client 136 to be received, while the data center firewall 416 may be configured to allow incoming network traffic emanating from the CMS aggregator 128 to be received.

In various embodiments, a particular CMS aggregator 128 may be implemented in combination with a particular CMS client 136 to provide a split proxy that allows an associated data center asset 244 to securely communicate with a data center monitoring and management console 118. In various embodiments, the split proxy may be implemented in a client/server configuration. In certain of these embodiments, the CMS client 136 may be implemented as the client component of the client/server configuration and the CMS aggregator 128 may be implemented as the server component. In certain of these embodiments, one or more connectivity management operations may be respectively performed by the CMS aggregator 128 and the CMS client 136 to establish a secure tunnel connection 418 through a particular network 140, such as the Internet.

In various embodiments, the secure tunnel connection 418 may be initiated by the CMS client 136 first determining the address of the CMS aggregator 128 it intends to connect to. In these embodiments, the method by which the address of the CMS aggregator 128 is determined is a matter of design choice. Once the address of the CMS aggregator 128 is determined, the CMS client 136 uses it to establish a secure Hypertext Transport Protocol (HTTPS) connection with the CMS aggregator 128 itself.

In response, the CMS aggregator 128 sets its HTTPS Transport Layer Security (TLS) configuration to “request TLS certificate” from the CMS client 136, which triggers the CMS client 136 to provide its requested TLS certificate 408. In certain embodiments, the CMS authentication 426 service may be implemented to generate and provision the TLS certificate 408 for the CMS client 136. In certain embodiments, the CMS client 136 may be implemented to generate a self-signed TLS certificate if it has not yet been provisioned with one from the CMS authentication 426 service.

In various embodiments, the CMS client 136 may then provide an HTTP header with a previously-provisioned authorization token. In certain embodiments, the authorization token may have been generated and provisioned by the CMS authentication 426 service once the CMS client has been claimed. As used herein, a claimed CMS client 136 broadly refers to a particular CMS client 136 that has been bound to an account associated with a user, such as a customer, of one or more data center services 432 provided by the data center monitoring and management console 118.

In certain embodiments, a CMS client 136 may be implemented to maintain its claimed state by renewing its certificate 408 and being provided an associated claim token. In these embodiments, the frequency, or conditions under which, a CMS client's certificate 408 is renewed, or the method by which it is renewed, or both, is a matter of design choice. Likewise, in these same embodiments, the frequency, or conditions under which, an associated claim token is generated, or the method by which it is provided to a CMS client 136, or both, is a matter of design choice.

In various embodiments, the CMS client 136 may be implemented to have a stable, persistent, and unique identifier (ID) after it is claimed. In certain of these embodiments, the CMS client's 136 unique ID may be stored within the authorization token. In these embodiments, the method by the CMS client's 136 unique ID is determined, and the method by which it is stored within an associated authorization token, is a matter of design choice.

Once the CMS client 136 has been claimed, it may be implemented to convert the HTTPS connection to a Websocket connection, familiar to those of skill in the art. After the HTTP connection has been converted to a Websocket connection, tunnel packet processing is initiated and the CMS aggregator 128 may then perform a Representational State Transfer (REST) to request the CMS client 136 to validate its certificate 408. In certain embodiments, the validation of the CMS client's 136 certificate 408 is performed by the CMS authorization 430 service.

In various embodiments, the validation of the CMS client's 136 certificate 408 is performed to determine a trust level for the CMS client 136. In certain of these embodiments, if the CMS client's 136 certificate 408 is validated, then it is assigned a “trusted” classification. Likewise, if CMS client's 136 certificate 408 fails to be validated, then it is assigned an “untrusted” classification.

Accordingly, certain embodiments of the invention reflect an appreciation that “trusted” and “claimed,” as used herein as they relate to a CMS client 136 are orthogonal. More specifically, “trust” means that the channel of communication can be guaranteed. Likewise, “claimed” means the CMS client 136 can be authenticated and bound to a user, or customer, of one or more data center services 432 provided by the data center monitoring and management console 118.

In various embodiments, the resulting secure tunnel connection 418 may be implemented to provide a secure channel of communication through a data center firewall 416 associated with a particular data center 402 and a service provider firewall 420 associated with a particular data center monitoring and management console 118. In various embodiments, the CMS client 136, the secure tunnel connection 418, and the CMS aggregator 128 may be implemented to operate at the application level of the Open Systems Interconnection (OSI) model, familiar to those of skill in the art. Skilled practitioners of the art will likewise be aware that known approaches to network tunneling typically use the network layer of the OSI model. In certain embodiments, the CMS client 136 and the CMS aggregator 128 may be implemented to send logical events over the secure tunnel connection 418 to encapsulate and multiplex individual connection streams and associated metadata.

In various embodiments, the CMS discovery 424 service may be implemented to identify certain data center assets 244 to be registered and managed by the data center monitoring and management console 118. In various embodiments, the CMS discovery 424 service may be implemented to detect certain events published by a CMS aggregator 128. In certain embodiments, the CMS discovery 424 service may be implemented to maintain a database (not shown) of the respective attributes of all CMS aggregators 128 and CMS clients 136. In certain embodiments, the CMS discovery 424 service may be implemented to track the relationships between individual CMS clients 136 and the CMS aggregators 128 they may be connected to.

In various embodiments, the CMS discovery 424 service may be implemented to detect CMS client 136 connections and disconnections with a corresponding CMS aggregator 128. In certain of these embodiments, a record of such connections and disconnections is stored in a database (not shown) associated with the CMS inventory 428 service. In various embodiments, the CMS discovery 424 service may be implemented to detect CMS aggregator 128 start-up and shut-down events. In certain of these embodiments, a record of related Internet Protocol (IP) addresses and associated state information is stored in a database (not shown) associated with the CMS inventory 428 service.

In various embodiments, the CMS authentication 426 service may be implemented to include certain certificate authority (CA) capabilities. In various embodiments, the CMS authentication 426 service may be implemented to generate a certificate 408 for an associated CMS client 136. In various embodiments, the CMS authentication 426 service may be implemented to use a third party CA for the generation of a digital certificate for a particular data center asset 244. In certain embodiments, the CMS inventory 428 service may be implemented to maintain an inventory of each CMS aggregator 128 by an associated unique ID. In certain embodiments, the CMS inventory 428 service may likewise be implemented to maintain an inventory of each CMS client 136 by an associated globally unique identifier (GUID).

In various embodiments, the CMS authorization 430 service may be implemented to authenticate a particular data center asset 244 by requesting certain proof of possession information, and then processing it once it is received. In certain of these embodiments, the proof of possession information may include information associated with whether or not a particular CMS client 136 possesses the private keys corresponding to an associated certificate 408. In various embodiments, the CMS authorization 430 service may be implemented to authenticate a particular CMS client 136 associated with a corresponding data center asset 244. In certain of these embodiments, the CMS authorization 430 service may be implemented to perform the authentication by examining a certificate 408 associated with the CMS client 136 to ensure that it has been signed by the CMS authentication 426 service.

In various embodiments, the service mesh proxy 434 may be implemented to integrate knowledge pertaining to individual data center assets 244 into a service mesh such that certain data center services 432 have a uniform method of transparently accessing them. In various embodiments, the service mesh proxy 434 may be implemented with certain protocols corresponding to certain data center assets 244. In certain embodiments, the service mesh proxy 434 may be implemented to encapsulate and multiplex individual connection streams and metadata over the secure tunnel connection 418. In certain embodiments, these individual connection streams and metadata may be associated with one or more data center assets 244, one or more data center services 432, one or more CMS clients 136, and one or more CMS aggregators 128, or a combination thereof.

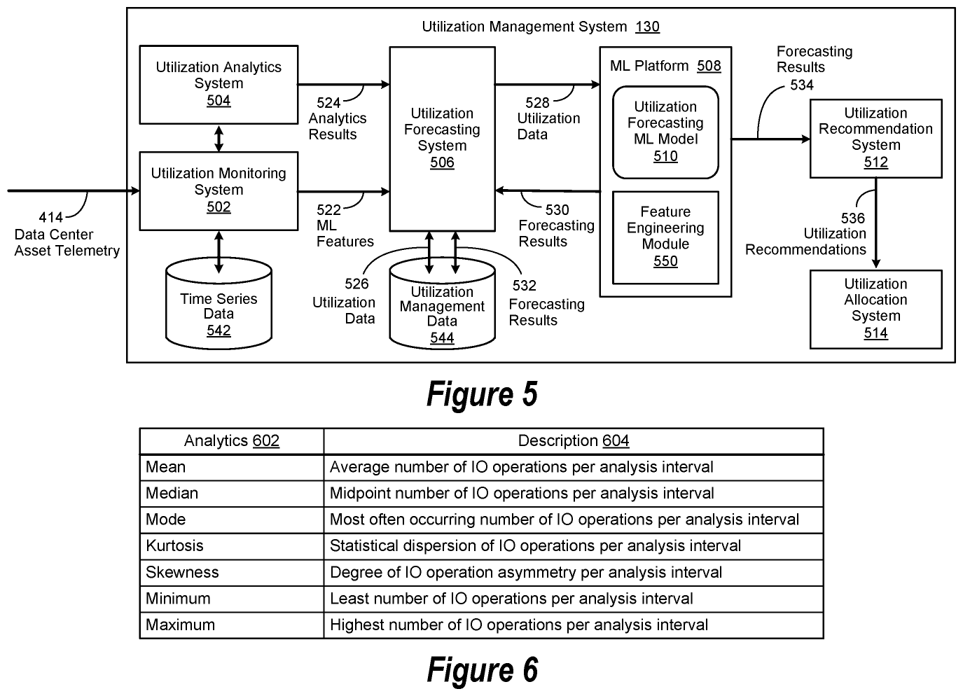

FIG. 5 is a simplified block diagram showing the performance of certain utilization management operations implemented in accordance with an embodiment of the invention. In various embodiments, a utilization management system 130 may be implemented to include a utilization monitoring system (UMS) 502, a utilization analytics system (UAS) 504, a utilization forecasting system (UFS) 506, a machine learning (ML) platform 508, a utilization recommendation system (URS) 512, and a utilization allocation system 514, or a combination thereof. In certain of these embodiments, the ML platform 508 may be implemented to include a utilization forecasting ML model 510, or a feature engineering module 550, or both. In various embodiments, the utilization management system 130 may be implemented to perform a utilization management operation, described in greater detail herein. In various embodiments, a utilization management operation may be implemented to include one or more utilization monitoring operations, utilization analysis operations, utilization forecasting operations, utilization machine learning operations, utilization recommendation operations, utilization allocation operations, feature clustering operations, or ML regression analysis operations, or a combination thereof.

In various embodiments, the UMS 502 may be implemented to perform a utilization monitoring operation. As used herein, a utilization monitoring operation broadly refers to any task, function, operation, procedure, or process performed to monitor and collect certain data center asset telemetry 414, described in greater detail herein, associated with the utilization of one or more data center assets, or one or more of their respective components, or a combination thereof, used to service a particular workload during a particular interval of time, or a segment thereof. In various embodiments, the data center asset telemetry 414 may contain certain time series data. Skilled practitioners of the art will be familiar with time series data, which in general usage refers to a sequence of data collected over consistent intervals of time, as described in greater detail herein. In various embodiments, the UMS 502 may be implemented to store, and access, certain time series data in a repository of time series data 542.

In various embodiments, the UMS 502 may be implemented to process the data center asset telemetry 414 it may receive to identify certain ML features, described in greater detail herein, associated with the utilization of one or more data center assets, or one or more of their respective components, or a combination thereof, used to service a particular workload during a particular interval of time, or a segment thereof. Those of skill in the art will be familiar with a ML feature, which in common usage generally refers to an attribute associated with an input or sample, such as an individual measurable property or characteristic of a phenomenon. Skilled practitioners of the art will likewise be aware that such features are typically used as independent variables in ML models, such as the utilization forecasting ML model 510 shown in FIG. 5. In various embodiments, the UMS 502 may be implemented to provide ML features 522 it may identify to the UFS 506.

In various embodiments, the UMS 502 may be implemented to process the data center asset telemetry 414 it may receive to identify certain analytical data associated with the utilization of one or more data center assets, or one or more of their respective components, or a combination thereof, used to service a particular workload during a particular time interval, or a segment thereof. In certain of these embodiments, such analytical data may include key performance indicator (KPI) metrics. Examples of such KPI metrics may include utilization of a data center asset's associated components, such as its processor, memory, storage capacity, network throughput, and so forth. In various embodiments, the UMS 502 may be implemented to provide certain analytical data it may identify to the UAS 504.

In various embodiments, the UAS 504 may be implemented to use the analytical data it receives from the UMS 502 to perform a utilization analysis operation. As used herein, a utilization analysis operation broadly refers to any task, function, operation, procedure, or process performed to analyze the utilization of one or more data center assets, or one or more components thereof, used to service a particular workload during a particular time interval, or a segment thereof. In various embodiments, performance of one or more utilization analysis operations may result in the generation of certain data center asset utilization analytics results, described in greater detail herein. In various embodiments, the UAS 504 may be implemented to provide certain utilization analytics results 524 to the UFS 506.

In various embodiments, the UFS 506 may be implemented to perform a utilization forecasting operation. As used herein, a utilization forecasting operation broadly refers to any task, function, operation, procedure, or process performed to forecast the utilization of one or more data center assets, or one or more their respective components, or a combination thereof, during a particular interval of time, or a segment thereof, in the future. In various embodiments, the ML features 522 provided by the UMS 502, and the utilization analytics results 524 provided by the UAS 504, may be used by the UFS 506 as data center asset utilization data in the performance of certain data center asset utilization forecasting operations.

In various embodiments, the UFS 506 may be implemented to provide certain utilization data 528 to the ML platform 508. In various embodiments, the ML platform 508 may be implemented to use the utilization data 528 it has received from the UFS 506 to perform a utilization machine learning operation. As used herein, a utilization machine learning operation broadly refers to any task, function, operation, procedure, or process performed to utilize one or more known ML approaches to forecast the utilization of one or more data center assets, or one or more their respective components, or a combination thereof, to service a particular workload during a particular interval of time, or a segment thereof, in the future.

Skilled practitioners of the art will be familiar with the concept of machine learning (ML), which is a discipline of artificial intelligence (AI) that provides machines the ability to automatically learn from data, current observations, past experience, and statistical analysis to identify patterns and forecast future behaviors with minimal human intervention. In various embodiments, the ML platform 508 may be implemented to use certain utilization data 528 it might receive from the UFS 506 in the performance of a utilization machine learning operation to train the resource utilization forecasting ML model 510. As used herein, a utilization forecasting ML model 510 broadly refers to any ML model used, as described in greater detail herein, to forecast the utilization of one or more data center assets, or one or more their respective components, or a combination thereof, to service a particular workload during a particular interval of time, or a segment thereof, in the future.

In various embodiments, the utilization forecasting ML model 510 may be based upon a Random Forest based Multi-output Regression algorithm, familiar to those of skill in the art. Various embodiments of the invention reflect an appreciation that such a algorithm provides a balance between accuracy and time-based output. In particular, the multi-output regression analysis provided by the model allows deducing output for different variables for one set of inputs. Likewise, the Random Forest approach adds additional accuracy to the multi-output regression method, which assists in overcoming the overfitting issue typically encountered with other regression analysis approaches when dealing with significantly higher numbers of features.

In various embodiments, the feature engineering module 550 may be implemented to perform one or more feature clustering operations, or one or more ML regression analysis operations, or a combination thereof, as described in greater detail herein. As used herein, a feature clustering operation broadly refers to any unsupervised machine learning task, function, operation, procedure, or process performed to separate ML features, described in greater detail herein, into homogeneous groups. In various embodiments, one or more feature clustering operations may be performed to utilize hierarchical feature clustering to identify intricate utilization patterns of one or more data center assets, or one or more their respective components, or a combination thereof, during a particular interval of time, or a segment thereof. Various embodiments of the invention reflect an appreciation that the use of such hierarchical feature clustering may enable the utilization forecasting ML model 510 to distinguish and capture certain nuances that may lead to more accurate forecasting of the utilization of a particular data center asset, or one or more of its respective components, or a combination thereof, during a particular interval of time, or a segment thereof.

As likewise used herein, an ML regression analysis operation broadly refers to any machine learning task, function, operation, procedure, or process performed to analyze the relationship(s) between independent variables, or features, and a dependent variable or outcome. Various embodiments of the invention reflect an appreciation that such ML regression analysis operations may be advantageously performed to predict continuous outcomes. In various embodiments, one or more ML regression analysis operations may be specific to a particular feature cluster, as described in greater detail herein. In various embodiments, the feature engineering module 550 may be implemented to use the trained utilization forecasting ML model 510 in the performance of one or more feature clustering operations, or one or more ML regression analysis operations, or a combination thereof, as likewise described in greater detail herein.

In various embodiments, the ML platform 508 may be implemented to use the trained utilization forecasting ML model 510, or the feature engineering module 550, or the two in combination, to forecast the utilization of one or more data center assets, or one or more their respective components, or a combination thereof, to service a particular workload during a particular interval of time, or a segment thereof, in the future. In certain of these embodiments, the ML platform 508 may be implemented to provide such forecasting results 530 to the UFS 506. In various embodiments, the UFS 506 may be implemented to store and access certain utilization data 526 and forecasting results 532 it may receive in a repository of utilization management data 544. In certain of these embodiments, the UFS 506 may be implemented to use certain utilization data 526 and forecasting results 532 stored in the repository of utilization management data 536 in the performance of one or more utilization forecasting operations.

In various embodiments, the ML platform 508 may be implemented to provide certain forecasting results 534 to the URS 512. In various embodiments, the URS 512 may be implemented to use one forecasting results 534 it may receive from the ML platform 508 in the performance of a utilization recommendation operation. As used herein, a utilization recommendation operation broadly refers to any task, function, operation, procedure, or process performed to generate a recommendation related to the utilization of one or more data center assets, or one or more their respective components, or a combination thereof, to service a particular workload during a particular interval of time, or a segment thereof, in the future.

In various embodiments, the URS 512 may be implemented to provide certain utilization recommendations 536 it may generate to the utilization allocation system 514. In certain of these embodiments, the utilization allocation system 514 may be implemented to use one or more utilization recommendations 536 it may receive from the URS 512 in the performance of a utilization allocation operation. As used herein, a utilization allocation operation broadly refers to any task, function, operation, procedure, or process performed to allocate, or reallocate, the utilization of one or more data center assets, or one or more their respective components, or a combination thereof, to service a particular workload during a particular interval of time, or a segment thereof, in the future.

FIG. 6 is a table showing example utilization analytics used in the performance of a utilization forecast operation implemented in accordance with an embodiment of the invention to forecast the utilization of certain data center assets used to service a particular workload. In various embodiments, certain utilization analytics 602, described 604 in the table shown in FIG. 6, may be used in the performance of one or more utilization analytics operations, as described in greater detail herein, to generate certain utilization analysis information. In certain of these embodiments, the resulting utilization analysis information may in turn be used, as likewise described in greater detail herein, in the performance of one or more utilization forecasting operations to forecast the utilization of one or more data center assets, or one or more their respective components, or a combination thereof, to service a particular workload during a particular interval of time, or a segment thereof, in the future. Skilled practitioners of the art will recognize that many such examples of utilization analytics 602, respectively corresponding to the utilization of a particular data center asset, are possible. Accordingly, the foregoing is not intended to limit the spirit, scope, or intent of the invention.

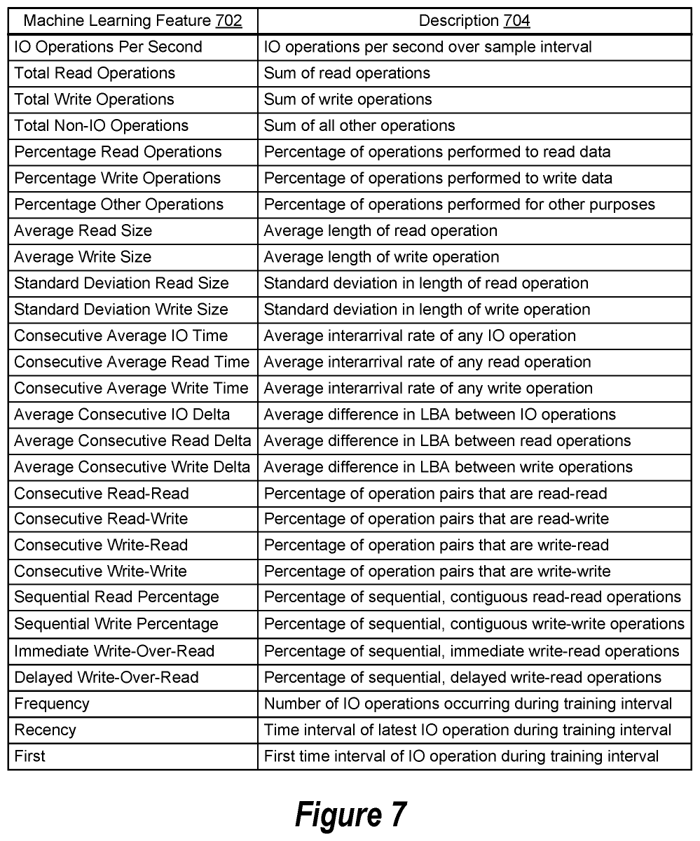

FIG. 7 is a table showing example machine learning (ML) features used in the performance of a utilization forecast operation implemented in accordance with an embodiment of the invention to forecast the utilization of certain data center assets used to service a particular workload. In various embodiments, certain utilization ML features 702, described 704 in the table shown in FIG. 7, may be used in the performance of one or more utilization forecasting operations, to forecast the utilization of one or more data center assets, or one or more their respective components, or a combination thereof, to service a particular workload during a particular interval of time, or a segment thereof, in the future. Skilled practitioners of the art will recognize that many such examples of utilization ML features 702, respectively corresponding to the utilization of a particular data center asset, are possible. Accordingly, the foregoing is not intended to limit the spirit, scope, or intent of the invention.

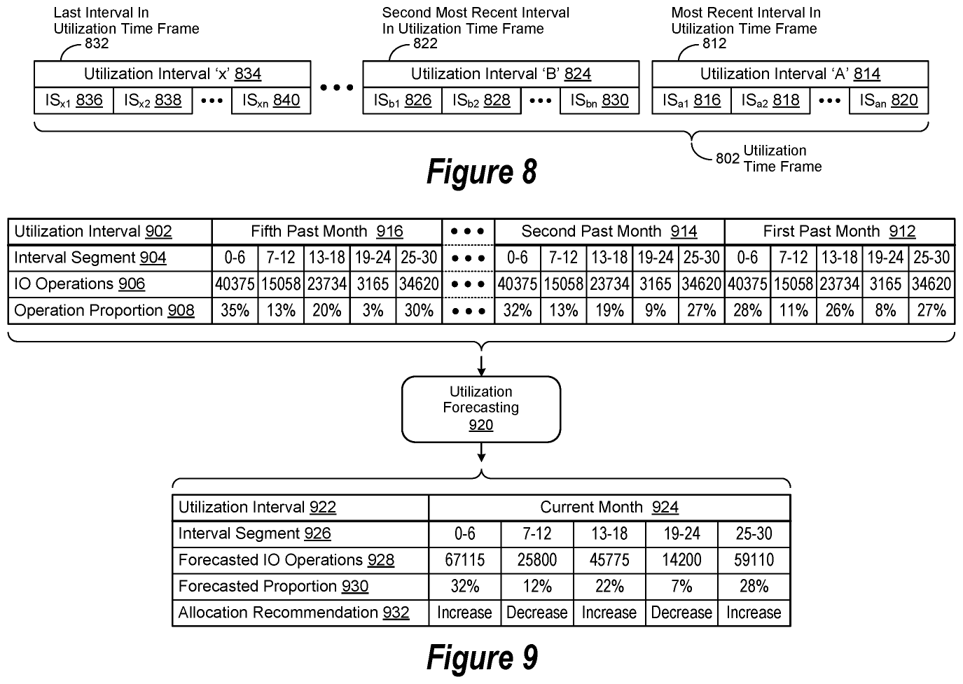

FIG. 8 shows utilization time intervals, and associated interval segments, used in the performance of a utilization forecast operation implemented in accordance with an embodiment of the invention to forecast the utilization of certain data center assets used to service a particular workload. In various embodiments, a data center asset utilization time frame 802 may be implemented to include a series of utilization time intervals, such as utilization time intervals ‘A’ 814, and ‘B’ 824 through ‘x’ 834, shown in FIG. 8. In various embodiments, each utilization time interval may be implemented to include a corresponding series of interval segments. For example, as shown in FIG. 8, utilization time interval ‘A’ 814 includes interval segments ‘ISₐ₁’ 816 and ‘ISₐ₂’ 818 through ‘ISₐₙ’ 820. Likewise, utilization time intervals ‘B’ 824 through ‘x’ 834 respectively include interval segments ‘IS_{b1}’ 826 and ‘IS_{b2}’ 828 through ‘IS_{bn}’ 820 and interval segments ‘ISₓ₁’ 816 and ‘ISₓ₂’ 818 through ‘ISₓₙ’ 820.

In various embodiments, one utilization time interval, or one or more of its associated interval segments, may be implemented as a reflect the utilization of one or more data center assets, or one or more their respective components, or a combination thereof, to service a particular workload during a particular interval of time, or a segment thereof. In various embodiments, one or more utilization time intervals, or one or more of their associated interval segments, or a combination thereof, may be implemented as time series data, described in greater detail herein. In certain of these embodiments, one utilization time interval, or one or more of its associated interval segments, or a combination thereof, may be referenced in a set of time series data as preceding another utilization time interval, or one or more of its associated interval segments, or a combination thereof, in a particular utilization time frame 802. For example, as shown in FIG. 8, utilization time interval ‘A’ 814 is the most recent 812 utilization time interval in the utilization time frame 802, while utilization time interval ‘B’ 824 is the second most recent 822 utilization time interval and utilization time interval ‘x’ 834 is the last 832 utilization time interval.

FIG. 9 shows example utilization time intervals, and associated interval segments, implemented in accordance with an embodiment of the invention to forecast the utilization of certain data center assets used to service a particular workload. In various embodiments, utilization data corresponding to the utilization of one or more data center assets, or one or more their respective components, or a combination thereof, to service a particular workload during a particular utilization time interval or interval segment may be collected. In the example shown in FIG. 9, the utilization data is for the number of input/output (IO) operations 906 performed, which is collected during utilization time intervals 902 for the first 912 past month and the second 914 through fifth 916 past months. As likewise shown in FIG. 9, each utilization time interval 902 is thirty days, and includes five interval segments 904, each of which is six days in duration. To continue the example, one or more utilization analysis operations, described in greater detail herein, may be performed to generate an IO operation proportion 908 value for each interval segment 904 of each utilization time interval 902.

To continue the example further, the collected utilization data corresponding to IO operations 906, and their corresponding IO operation proportion 908 values, may then be used in the performance of one or more utilization forecasting operations 920, described in greater detail herein. To continue the example yet further, performance of the one or more utilization forecasting operations 920 results in the generation of a forecasted number of IO operations 928, and their respectively corresponding IO operation proportion 930 values, for the utilization time interval 922 of the current month 924 and each of its associated interval segments 926. To continue the example further yet, one or more utilization recommendation operations, likewise described in greater detail herein, may be performed to generate utilization allocation recommendation 932.

In various embodiments, the utilization allocation recommendation 932 may be implemented to recommend increasing, maintaining, or decreasing the utilization of the one or more data center assets, or one or more their respective components, or a combination thereof, to service the workload during the utilization time interval 922 of the current month 924, or one or more of its associated interval segments 926. In various embodiments, the utilization recommendation 932 may be implemented to recommend shifting from one service tier classification (e.g., “hot”, or “Tier 1”) to another (e.g., “cold”, or “Tier 3”). Those of skill in the art will recognize that many such embodiments are possible. Accordingly, the foregoing is not intended to limit the spirit, scope, or intent of the invention.

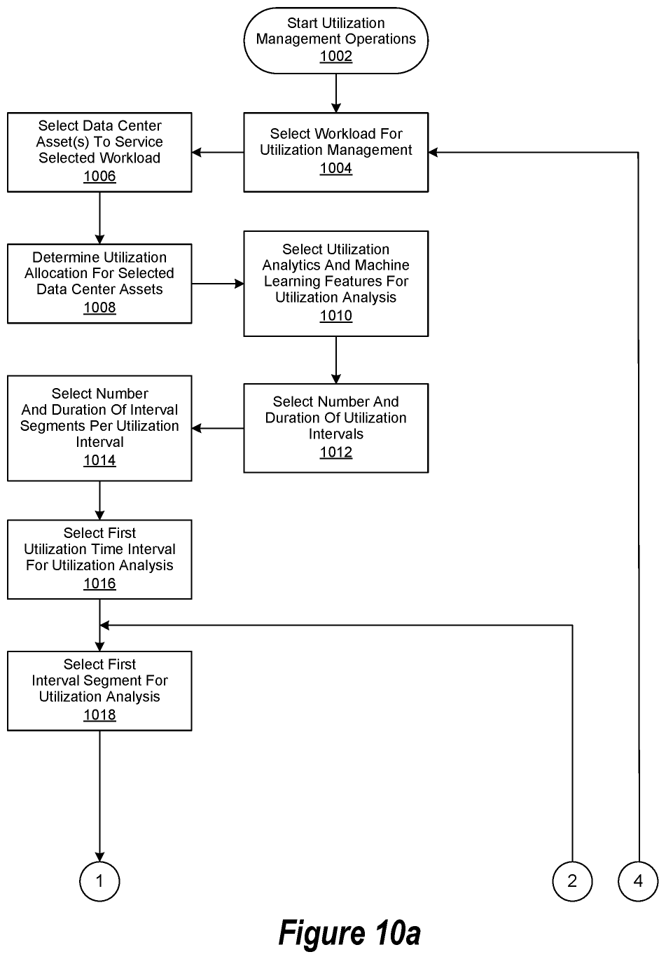

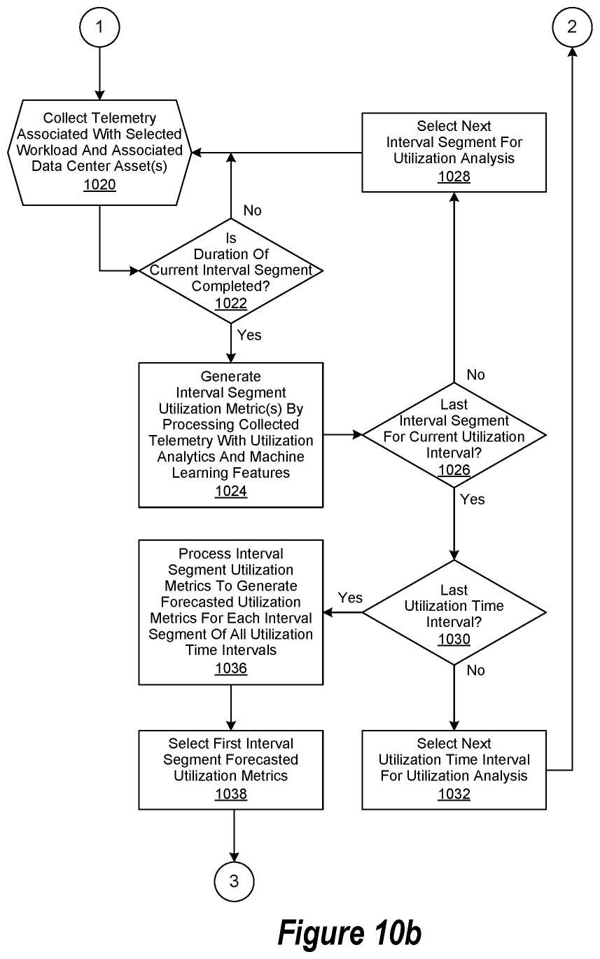

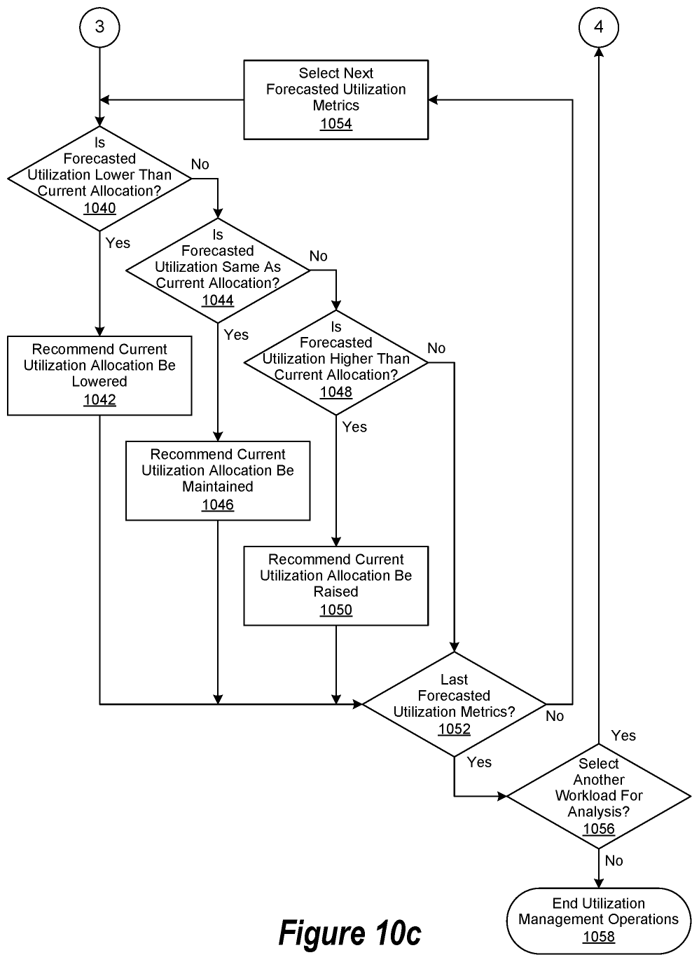

FIGS. 10a through 10c are a flowchart showing the performance of certain utilization management operations implemented in accordance with an embodiment of the invention. In this embodiment, utilization management operations are begun in step 1002, followed by the selection of a workload for utilization management in step 1004. Data center assets are then selected in step 1006 to service the selected workload.

Once the data center assets are selected, their respective utilization allocation is then determined in step 1008. Thereafter, utilization analytics and machine learning features, described in greater detail herein, are then selected in step 1010 for use in various utilization analysis operations, likewise described in greater detail herein. The number and duration of utilization intervals, described in greater detail herein, are then selected in step 1012, followed by the selection in step 1014 of the number and duration of interval segments, likewise described in greater detail herein, for each utilization interval.

The first utilization interval for utilization analysis is then selected in step 1016, followed by the selection of its first associated interval segment in step 1018. Ongoing utilization monitoring operations, described in greater detail herein, are then performed on step 1020 to collect data center asset telemetry associated with the selected workload and the utilization of the data center asset(s) used to service it. A determination is then made in step 1022 whether the duration of the current interval segment is completed. If not, then the process is continued, proceeding with step 1020.

Otherwise, interval segment utilization metrics, described in greater detail herein, are generated in step 1024 by processing collected data center asset telemetry with certain utilization analytics and machine learning features, as described in greater detail herein. A determination is then made in step 1026 whether the current interval segment is the last for the current utilization time interval. If not, then the next interval segment associated with the current utilization time interval is selected in step 1028 and the process is continued, proceeding with step 1020.

Otherwise, a determination is made in step 1030 whether the current utilization time interval is the last. If not, then the next utilization time interval is selected in step 1032 and the process is continued, proceeding with step 1018. Otherwise, the previously-generated interval segment utilization metrics are then processed in step 1036 to generate forecasted utilization metrics for each interval segment for all associated utilization time intervals.

The forecasted utilization metrics for the first interval segment are then selected in step 1038, followed by a determination being made in step 1040 whether the forecasted utilization metrics are lower than the current utilization allocation. If so, then a recommendation is generated in step 1042 that the current utilization allocation be lowered. Otherwise, a determination is made in step 1044 whether the forecasted utilization metrics are the same as the current utilization allocation. If so, then a recommendation is generated in step 1046 that the current utilization allocation be maintained. Otherwise, a determination is made in step 1048 whether the forecasted utilization metrics are higher than the current utilization allocation. If so, then a recommendation is generated in step 1050 that the current utilization allocation be raised.

Otherwise, or once the recommendation to raise or maintain the utilization allocation are respectively generated in steps 1042 and 1044, a determination is then made in step 1042 whether the last forecasted utilization metrics have been processed to generate a utilization allocation recommendation. If not, then the next forecasted utilization metrics are selected in step 1054 and the process is continued, proceeding with step 1040. Otherwise, a determination is made in step 1056 whether to select another workload for utilization management operations. If so, the process is continued, proceeding with step 1004. Otherwise, utilization management operations are ended in step 1058.

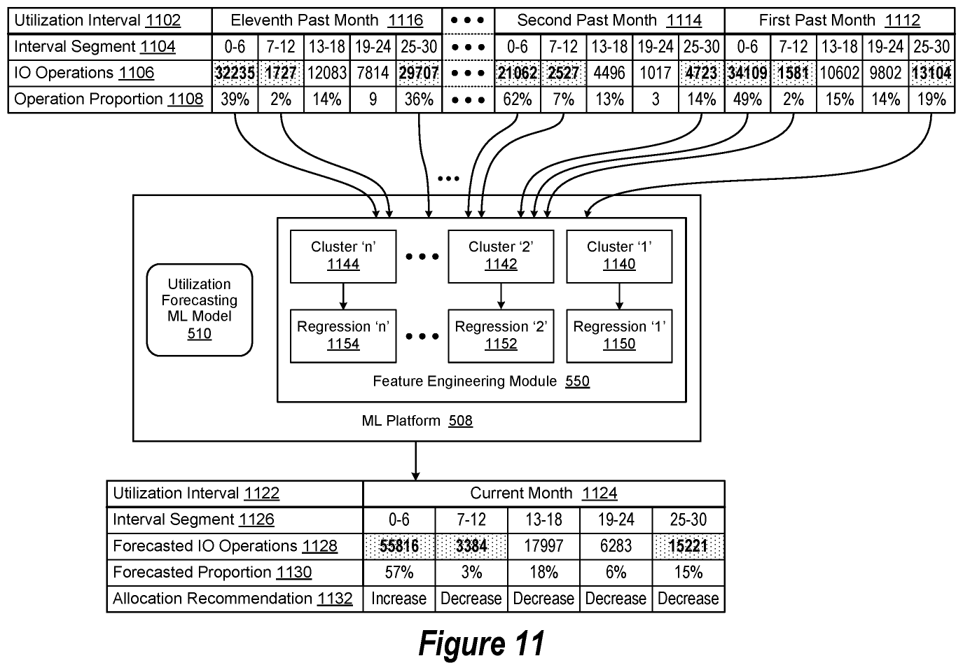

FIG. 11 shows example utilization intervals, and associated interval segments, used in the performance of feature clustering and machine learning (ML) regression analysis operations implemented in accordance with an embodiment of the invention to forecast the utilization of certain data center assets used to service a particular workload. In various embodiments, utilization data corresponding to the utilization of one or more data center assets, or one or more their respective components, or a combination thereof, to service a particular workload during a particular utilization time interval or interval segment may be collected. For example, the utilization data shown in FIG. 11 is for the number of input/output (IO) operations 1106 performed, which is collected during utilization time intervals 1102 for the first 1112 past month and the second 1114 through eleventh 1116 past months. As likewise shown in FIG. 11, each utilization time interval 1102 is thirty days, and includes five interval segments 1104, each of which is six days in duration. To continue the example, one or more utilization analysis operations, described in greater detail herein, may be performed to generate an IO operation proportion 1108 value for each interval segment 1104 of each utilization time interval 1102.

In various embodiments, an ML platform 508 may be implemented to include a utilization forecasting ML model 510, or a feature engineering module 550, or a combination of the two, as described in greater detail herein. In various embodiments, the feature engineering module 550 may be implemented, as likewise described in greater detail herein, to perform one or more feature clustering operations, or one or more ML regression analysis operations, or a combination thereof. To continue the example further, the feature engineering module 550 may be implemented in various embodiments to use certain collected utilization data corresponding to each utilization interval 1102, their respective interval segments 1104, the number of IO operations 1106 performed therein, and their respective operation proportion 1108 values in the performance of one or more feature clustering operations to respectively generate feature clusters ‘1’ 1140, and ‘2’ 1142 through ‘n’ 1144.

In various embodiments, a value of ‘c’ may be used to reference the number of feature clusters formed, using hierarchical clustering, where a value of ‘k’ is determined through the use of an elbow method, familiar to skilled practitioners of the art. In various embodiments, a ‘v’ number of volumes may be used for training the utilization forecasting ML model 510. As an example, the eleven prior utilization intervals 1102 of IO operations 1106 may be used for the purpose of generating regression analysis target variables.

To continue the example yet further, the feature engineering module 550 may be implemented in various embodiments to use certain feature information respectively associated with feature clusters ‘1’ 1140, and ‘2’ 1142 through ‘n’ 1144, and the utilization forecasting ML model 550, in the performance of one or more ML regression operations to generate regression analysis results ‘1’ 1150, and ‘2’ 1152 through ‘n’ 1154 respectively corresponding to feature clusters ‘1’ 1140, and ‘2’ 1142 through ‘n’ 1144. In various embodiments, the respectively generated regression analysis results ‘1’ 1150, and ‘2’ 1152 through ‘n’ 1154 corresponding to feature clusters ‘1’ 1140, and ‘2’ 1142 through ‘n’ 1144 may be used to learn homogenous patterns and avoid noise induced due to the heterogeneity of certain workloads and their associated IO patterns. As an example, the prediction of the number of IO operations 1128 that may be performed during a particular interval segment 1126 of a current utilization interval 1122 may be based upon the number of IO operations 1106 that may have been respectively performed during the same interval segment 1104 during each of the utilization interval 1102 corresponding to the previous eleven months.

In various embodiments, the interval segment 1104 respectively associated with feature clusters ‘1’ 1140, and ‘2’ 1142 through ‘n’ 1144 may be determined by using a Euclidean distance with each feature cluster centroid. In certain of these embodiments, the interval segment 1104 that is closest amongst the ‘c’ feature centroids can then be identified as the feature cluster that may be receive a recommendation to increase, maintain, or decrease the utilization of one or more associated data center assets, or one or more their respective components, or a combination thereof. In various embodiments, the selected feature cluster's associated ML regression analysis results may be used to predict the distribution of the current month's 1124 utilization interval 1122 for each of its associated interval segments 1126.

To continue the example further yet, performance of one or more utilization forecasting operations, described in greater detail herein, results in the generation of a forecasted number of IO operations 1128, and their respectively corresponding IO operation proportion 1130 values, for the utilization time interval 1122 of the current month 1124 and each of its associated interval segments 1126. To continue the example yet further, one or more utilization recommendation operations, likewise described in greater detail herein, may be performed to generate utilization allocation recommendation 1132.

In various embodiments, the utilization allocation recommendation 1132 may be implemented to recommend increasing, maintaining, or decreasing the utilization of the one or more data center assets, or one or more their respective components, or a combination thereof, to service the workload during the utilization time interval 1122 of the current month 1124, or one or more of its associated interval segments 1126. In various embodiments, the utilization recommendation 1132 may be implemented to recommend shifting from one service tier classification (e.g., “hot”, or “Tier 1”) to another (e.g., “cold”, or “Tier 3”). Those of skill in the art will recognize that many such embodiments are possible. Accordingly, the foregoing is not intended to limit the spirit, scope, or intent of the invention.

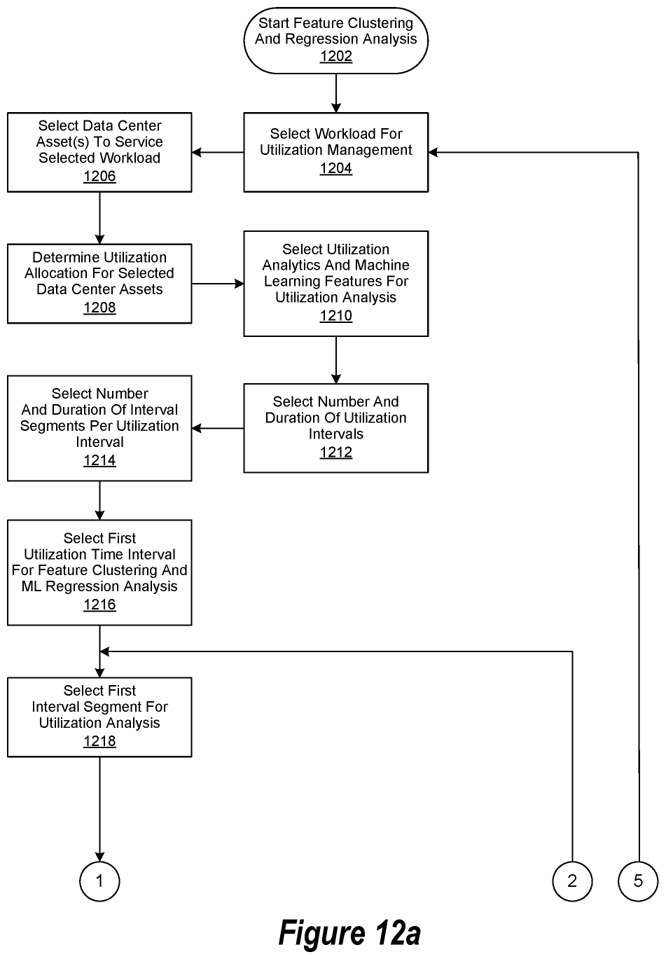

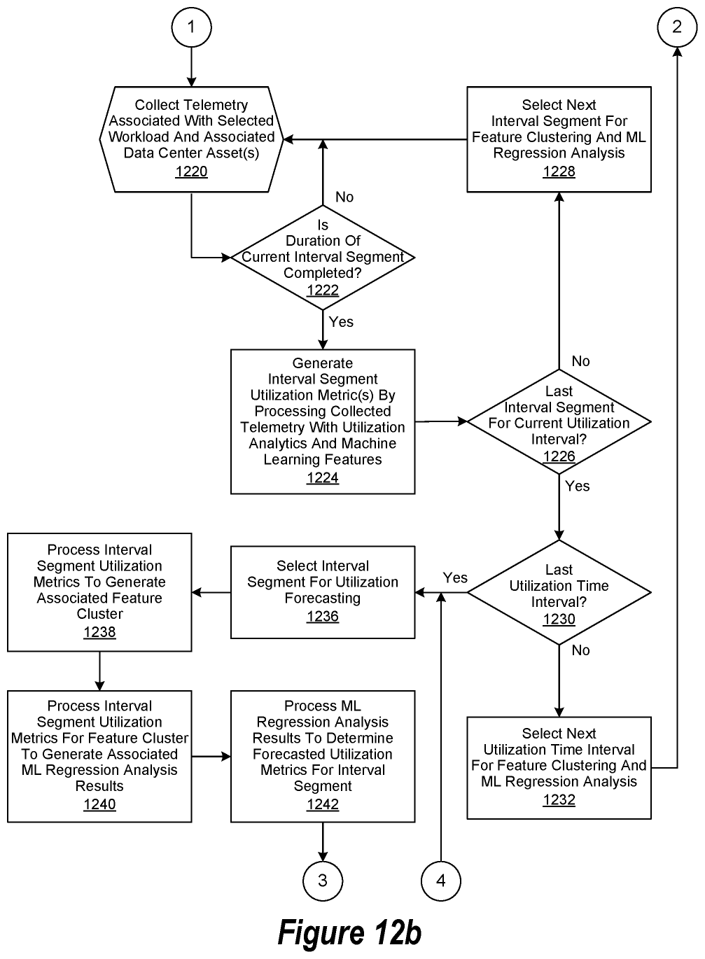

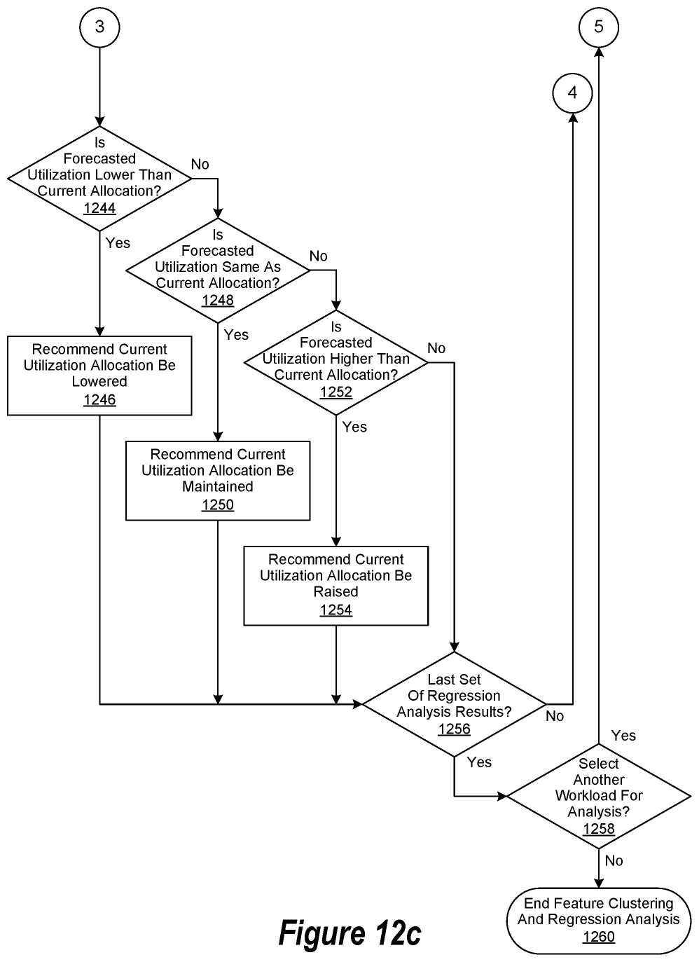

FIGS. 12a through 12c are a flowchart showing the performance of certain clustering and machine learning (ML) regression analysis operations implemented in accordance with an embodiment of the invention to forecast the utilization of certain data center assets. In this embodiment, feature clustering and ML regression analysis operations are begun in step 1202, followed by the selection of a workload for utilization management in step 1204. Data center assets are selected in step 1206 to service the selected workload.

Once the data center assets are selected, their respective utilization allocation is then determined in step 1208. Thereafter, utilization analytics and machine learning features, described in greater detail herein, are then selected in step 1210 for use in various utilization analysis operations, likewise described in greater detail herein. The number and duration of utilization intervals, described in greater detail herein, are then selected in step 1212, followed by the selection in step 1214 of the number and duration of interval segments, likewise described in greater detail herein, for each utilization interval.

The first utilization interval for feature clustering and ML regression analysis is then selected in step 1216, followed by the selection of its first associated interval segment in step 1218. Ongoing utilization monitoring operations, described in greater detail herein, are then performed on step 1220 to collect data center asset telemetry associated with the selected workload and the utilization of the data center asset(s) used to service it. A determination is then made in step 1222 whether the duration of the current interval segment is completed. If not, then the process is continued, proceeding with step 1220.

Otherwise, interval segment utilization metrics, described in greater detail herein, are generated in step 1224 by processing collected data center asset telemetry with certain utilization analytics and machine learning features, as described in greater detail herein. A determination is then made in step 1226 whether the current interval segment is the last for the current utilization time interval. If not, then the next interval segment associated with the current utilization time interval is selected in step 1228 and the process is continued, proceeding with step 1220.

Otherwise, a determination is made in step 1230 whether the current utilization time interval is the last. If not, then the next utilization time interval is selected in step 1232 and the process is continued, proceeding with step 1218. Otherwise, an interval segment is selected in step 1236 for utilization forecasting.

One or more feature clustering operations are then performed in step 1238 on interval segment utilization metrics corresponding to the selected interval segment, as described in greater detail herein, to generate associated feature clusters. Thereafter, one or more ML regression analysis operations, likewise described in greater detail herein, are then performed in step 1240 on the utilization metrics corresponding to each feature cluster to respectively generate associated ML regression analysis results. The resulting ML regression analysis results are then processed in step 1242 to determine the forecasted utilization metrics of associated data center assets, or a component thereof, for the interval segment.

A determination is then made in step 1244 whether the forecasted utilization metrics are lower than the current utilization allocation. If so, then a recommendation is generated in step 1246 that the current utilization allocation be lowered. Otherwise, a determination is made in step 1248 whether the forecasted utilization metrics are the same as the current utilization allocation. If so, then a recommendation is generated in step 1250 that the current utilization allocation be maintained. Otherwise, a determination is made in step 1252 whether the forecasted utilization metrics are higher than the current utilization allocation. If so, then a recommendation is generated in step 1254 that the current utilization allocation be raised.

Otherwise, or once the recommendation to raise or maintain the utilization allocation are respectively generated in steps 1244 and 1248, a determination is then made in step 1256 whether the last set of ML regression analysis results have been processed to generate a utilization allocation recommendation. If not, then the process is continued, proceeding with step 1236. Otherwise, a determination is made in step 1258 whether to select another workload for utilization management operations. If so, the process is continued, proceeding with step 1204. Otherwise, feature clustering and ML regression analysis operations are ended in step 1260.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a data center monitoring and management operation, comprising:
monitoring a workload executing on a data center asset;
analyzing utilization of the data center asset when the data center asset executes the workload;
training a machine learning model using the utilization of the data center asset when executing the workload, the training the machine learning model including performing a feature clustering operation using the utilization of the data center asset to provide separate groups of machine learning features; and,
generating a data center asset utilization forecast using the machine learning model.

2. The method of claim 1, wherein:
the training the machine learning model includes performing a regression analysis operation on the separate groups of machine learning features.

3. The method of claim 1, wherein:
the separate groups of machine learning features comprise homogeneous groups of machine learning features.

4. The method of claim 1, wherein:
the separate groups of machine learning features are separated based upon hierarchical features of utilization patterns of the utilization of the data center asset.

5. The method of claim 1, wherein:
the monitoring the workload uses telemetry regarding the workload provided by the data center asset;
data center asset utilization analysis information is generated using the telemetry regarding the workload provided by the data center asset.

6. The method of claim 5, wherein:
the training the machine learning model uses the telemetry regarding the workload and the data center asset utilization analysis information.

7. A system comprising:
a processor;
a data bus coupled to the processor; and,
a non-transitory, computer-readable storage medium embodying computer program code, the non-transitory, computer-readable storage medium being coupled to the data bus, the computer program code interacting with a plurality of computer operations and comprising instructions executable by the processor and configured for:
monitoring a workload executing on a data center asset;
analyzing utilization of the data center asset when the data center asset executes the workload;
training a machine learning model using the utilization of the data center asset when executing the workload, the training the machine learning model including performing a feature clustering operation using the utilization of the data center asset to provide separate groups of machine learning features; and,
generating a data center asset utilization forecast using the machine learning model.

8. The system of claim 7, wherein:
the training the machine learning model includes performing a regression analysis operation on the separate groups of machine learning features.

9. The system of claim 7, wherein:
the separate groups of machine learning features comprise homogeneous groups of machine learning features.

10. The system of claim 7, wherein:
the separate groups of machine learning features are separated based upon hierarchical features of utilization patterns of the utilization of the data center asset.

11. The system of claim 10, wherein:
the monitoring the workload uses telemetry regarding the workload provided by the data center asset;
data center asset utilization analysis information is generated using the telemetry regarding the workload provided by the data center asset.

12. The system of claim 11, wherein:
the training the machine learning model uses the telemetry regarding the workload and the data center asset utilization analysis information.

13. A non-transitory, computer-readable storage medium embodying computer program code, the computer program code comprising computer executable instructions configured for:
monitoring a workload executing on a data center asset;
analyzing utilization of the data center asset when the data center asset executes the workload;
training a machine learning model using the utilization of the data center asset when executing the workload, the training the machine learning model including performing a feature clustering operation using the utilization of the data center asset to provide separate groups of machine learning features; and,
generating a data center asset utilization forecast using the machine learning model.

14. The non-transitory, computer-readable storage medium of claim 13, wherein:
the training the machine learning model includes performing a regression analysis operation on the separate groups of machine learning features.

15. The non-transitory, computer-readable storage medium of claim 13, wherein:
the separate groups of machine learning features comprise homogeneous groups of machine learning features.

16. The non-transitory, computer-readable storage medium of claim 13, wherein:
the separate groups of machine learning features are separated based upon hierarchical features of utilization patterns of the utilization of the data center asset.

17. The non-transitory, computer-readable storage medium of claim 16, wherein:
the monitoring the workload uses telemetry regarding the workload provided by the data center asset;
data center asset utilization analysis information is generated using the telemetry regarding the workload provided by the data center asset.

18. The non-transitory, computer-readable storage medium of claim 17, wherein:
the training the machine learning model uses the telemetry regarding the workload and the data center asset utilization analysis information.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
